(19) United States
(12) Patent Application Publication
(10) Pub. No.: US 2023/0229505 A1
(43) Pub. Date: Jul. 20, 2023

(54) HARDWARE ACCELERATOR FOR PERFORMING COMPUTATIONS OF DEEP NEURAL NETWORK AND ELECTRONIC DEVICE INCLUDING THE SAME

(71) Applicant: DAEGU GYEONGBUK INSTITUTE OF SCIENCE AND TECHNOLOGY, Daegu (KR)

(72) Inventors: Seock Hwan NOH, Incheon (KR); Jae Ha KUNG, Daegu (KR); Ja Hyun KOO, Daegu (KR)

(73) Assignee: DAEGU GYEONGBUK INSTITUTE OF SCIENCE AND TECHNOLOGY, Daegu (KR)

(21) Appl. No.: 18/155,863

(22) Filed: Jan. 18, 2023

(30) Foreign Application Priority Data
Jan. 19, 2022 (KR) 10-2022-0008090
Dec. 27, 2022 (KR) 10-2022-0186268

(51) Int. Cl. G06F 9/50; G06F 7/544; G06F 7/53; G06F 7/50

(52) U.S. Cl. CPC G06F 9/5027; G06F 7/5443; G06F 7/5318; G06F 7/50

(57) ABSTRACT

A hardware accelerator includes a processing core including a plurality of multipliers configured to perform one-dimensional (1D) sub-word parallelism between a sign and a mantissa of a first tensor and a sign and a mantissa of a second tensor, a first processing device configured to operate in a two-dimensional (2D) operation mode in which results of computation by the plurality of multipliers are output, and a second processing device configured to operate in a three-dimensional (3D) operation mode in which results of computation by the plurality of multipliers are accumulated in a channel direction and then a result of accumulating the results of computation is output.

### CROSS-REFERENCE TO RELATED APPLICATION

This application is based on and claims priority under 35 U.S.C. § 119 to Korean Patent Application No. 10-2022-0008090, filed on Jan. 19, 2022, and Korean Patent Application No. 10-2022-0186268 filed on Dec. 27, 2022, in the Korean Intellectual Property Office, the disclosures of which are incorporated by reference herein in its entireties.

### BACKGROUND

### 1. Field

The disclosure relates to a hardware accelerator for performing computations of a deep neural network, and an electronic device including the hardware accelerator, and more particularly, to a hardware accelerator that supports learning and inference operations with various precisions by using block floating point and operates with high efficiency at each stage of the learning operation, and an electronic device including the hardware accelerator.

### 2. Description of the Related Art

Influenced by high-performance computing systems and ever-growing open-source data sets, deep learning has developed very rapidly. In addition, as accuracy improves, deep learning technology is being used in many applications such as computer vision, language modeling, or autonomous driving.

In order to use deep learning in an application, a process called training is required. In deep learning, training refers to a process of updating the weights of a deep neural network (DNN) through a particular data set. The better the weights are updated, the better DNN may perform a given task.

The training includes a forward pass step, a backward pass step, a weight update step, etc. The forward pass step is a process of computing the loss in a training process, and the backward pass step is a process of computing a gradient of a loss function. Gradients are usually obtained through a chain rule, and are propagated to all layers constituting a DNN in the opposite direction to the direction of the forward pass step. The weight update step is a process of updating the weights constituting a DNN, and an update is made by subtracting, from a current weight, a value obtained by multiplying the gradient of a loss function for the weight by a learning rate.

Such a training process requires a significantly large amount of computation, and thus, takes a lot of time when performed on central processing units (CPUs). Graphics processing units (GPUs) are more suitable for parallel processing, and thus consume less time than do CPUs, but show a low utilization rate due to their structural characteristics.

Recently, many dedicated hardware accelerators have been proposed to overcome the disadvantages of CPUs and GPUs. However, accelerators in the related art only support a particular precision or exhibit high efficiency only for particular training steps (e.g., a forward pass step and a backward pass step).

### SUMMARY

Additional aspects will be set forth in part in the description which follows and, in part, will be apparent from the description, or may be learned by practice of the presented embodiments of the disclosure.

According to an aspect of the disclosure, a hardware accelerator includes a plurality of multipliers that perform one-dimensional (1D) sub-word parallelism between the sign and mantissa of a first tensor and the sign and mantissa of a second tensor. The hardware accelerator may include a first processing device that operates in a two-dimensional (2D) operation mode for outputting results of computation by a plurality of multipliers. The hardware accelerator may include a second processing device that operates in a three-dimensional (3D) operation mode for accumulating results of computation by a plurality of multipliers in a channel direction and outputting a result of accumulating the results of computation.

According to another aspect of the disclosure, an electronic device includes a hardware accelerator that performs 1D sub-word parallelism between the sign and mantissa of a first tensor and the sign and mantissa of a second tensor by using a plurality of multipliers, and performs processing between a shared exponent of the first tensor and a shared exponent of the second tensor by using a shared exponent handler. The electronic device may include a processor configured to execute at least one instruction to control the hardware accelerator, based on deep neural network information including at least one of the number of layers in the deep neural network, the types of layers, the shapes of tensors, the dimensionality of the tensors, the operation mode, a bit precision, the type of batch normalization, the type of a pooling layer, and the type of a rectified linear unit (ReLU) function. The electronic device may include a memory storing the at least one instruction and the deep neural network.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing a deep learning operating environment in the related art;

FIG. 2 is a block diagram illustrating a configuration of an electronic device according to an embodiment;

FIG. 3 is a diagram for describing block floating point (BFP) according to an embodiment;

FIG. 4 is a diagram for describing major operations of a process of training a deep neural network, according to an embodiment;

FIG. 5 is a diagram for describing a two-dimensional (2D) operation mode and a three-dimensional (3D) operation mode, according to an embodiment;

FIG. 6 is a diagram for describing a configuration of a hardware accelerator according to an embodiment;

FIG. 7 is a diagram for describing a configuration of a subcore illustrated in FIG. 6;

FIG. 8 is a diagram for describing a detailed configuration of a processing unit illustrated in FIG. 7;

FIG. 9 is a diagram for describing a detailed configuration of a multiplier illustrated in FIG. 8;

FIG. 10 is a diagram for describing an operation of an electronic device according to an embodiment;

FIG. 11 is a diagram for describing a detailed configuration of a rectified linear unit (ReLU)-pool unit of FIG. 6;

FIG. 12 is a diagram for describing a detailed configuration of a core output buffer of FIG. 6;

FIG. 13 is a diagram for describing a detailed configuration of first in, first out (FIFO) of FIG. 6;

FIG. 14 is a diagram for describing a detailed configuration of a weight update unit of FIG. 6;

FIG. 15 is a diagram for describing a detailed configuration of an FP2BFP converter of FIG. 6;

FIG. 16 is a diagram for describing a detailed configuration of a quantization unit of FIG. 6;

FIG. 17 is a diagram for exemplarily describing how an input tensor is mapped to a processing core in a Conv3 layer;

FIG. 18 is a diagram for exemplarily describing how a weight tensor is mapped to a processing core in a Conv3 layer;

FIG. 19 is a diagram for describing an operation of a subcore according to a layer type of a deep neural network, according to an embodiment;

FIG. 20 is a diagram for describing an example of a mapping method in a 2D operation mode, according to an embodiment;

FIG. 21 is a diagram for describing an operation of an electronic device according to an embodiment;

FIG. 22 is a diagram for describing a detailed configuration of a shared exponent handler of FIG. 6; and

FIG. 23 is a block diagram exemplarily illustrating an electronic device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, the disclosure will be described in detail with reference to the accompanying drawings. In an information (data) transmission process performed in the disclosure, encryption/decryption may be applied when necessary, and the expression describing the information (data) transmission process in the disclosure and claims should be interpreted to include a case of encrypting/decrypting, although it is not mentioned. In the disclosure, expressions such as “transmitting (transferring) from A to B” or “receiving A from B” may include transmitting (transferring) or receiving with another medium therebetween and does not express only the direct transmitting (transferring) or receiving from A to B.

In describing the disclosure, it should be understood that the order of each operation is not limited, unless the preceding step should be performed logically and temporally prior to the subsequent operation. That is, except for exceptional cases as described above, even when a process described as the subsequent operation is performed prior to a process described as the preceding operation, it does not influence the nature of the disclosure and the claims should also be defined regardless of the order of the operation. Furthermore, in the specification, “A or B” does not only selectively indicate any one of A and B, but is defined to include both A and B. In addition, as used herein, the term ‘including’ may have meaning of further including other elements, in addition to the listed elements.

In the specification, essential elements necessary for the description of the disclosure are only described and elements with no relation with the gist of the disclosure may not be mentioned. In addition, it should not be interpreted as exclusive meaning of including only the mentioned elements, but should be interpreted as non-exclusive meaning of including other elements.

In the disclosure, the term “value” is defined as a concept including not only a scalar value, but also a vector.

In the disclosure, “convK layer” denotes a convolutional layer having a weight kernel size of K×K. For example, the weight kernel size of a “conv3 layer” is 3×3, the weight kernel size of a “conv5 layer” is 5×5, and the weight kernel size of the “conv7 layer” is 7×7.

In the disclosure, the term “one-dimensional (1D) sub-word parallelism” refers to an operation by which a series of sub-words are input in the form of a 1D array into a series of multipliers and then arithmetic operations are performed in parallel thereon. For example, it is assumed that 16-bit data of each of a first tensor and a second tensor includes four 4-bit sub-words, and the 4-bit sub-words are input into four multipliers. The four 4-bit sub-words of the first tensor may be input in the form of a 1D array into the four multipliers, respectively, and one of the four 4-bit sub-words of the second tensor may be input into all of the four multipliers. In this case, it may be expressed that 1D sub-word parallelism is performed on the first tensor. Next, the four 4-bit sub-words of the second tensor may be input in the form of a 1D array into the four multipliers, respectively, and and one of the four 4-bit sub-words of the first tensor may be input into all of the four multipliers. In this case, it may be expressed that 1D sub-word parallelism is performed on the second tensor. As 1D sub-word paralleleism is performed on each of the first tensor and the second tensor, 2D sub-word paralleleism may be implemented.

Components that are described herein with reference to the terms ‘unit’, ‘module’, ‘block’, ‘ . . . er or . . . or’, etc. and function blocks illustrated in drawings may be implemented as software, hardware, or a combination thereof. For example, the software may be machine code, firmware, embedded code, or application software. For example, the hardware may include an electrical circuit, an electronic circuit, an integrated circuit, a processor, a computer, an integrated circuit, integrated circuit cores, a pressure sensor, an inertial sensor, a microelectromechanical systems (MEMS) device, a passive element, or a combination thereof.

The mathematical operations and computations of each operation of the disclosure to be described below may be implemented as computer operations by a well-known coding method for the operations or computations, and/or coding conceived suitably to the disclosure.

The specific equations described below are described as examples from among many possible alternatives, and it should not be interpreted that the scope of the disclosure is not limited to the equations in the disclosure.

Hereinafter, various embodiments will be described in detail with reference to the accompanying drawings.

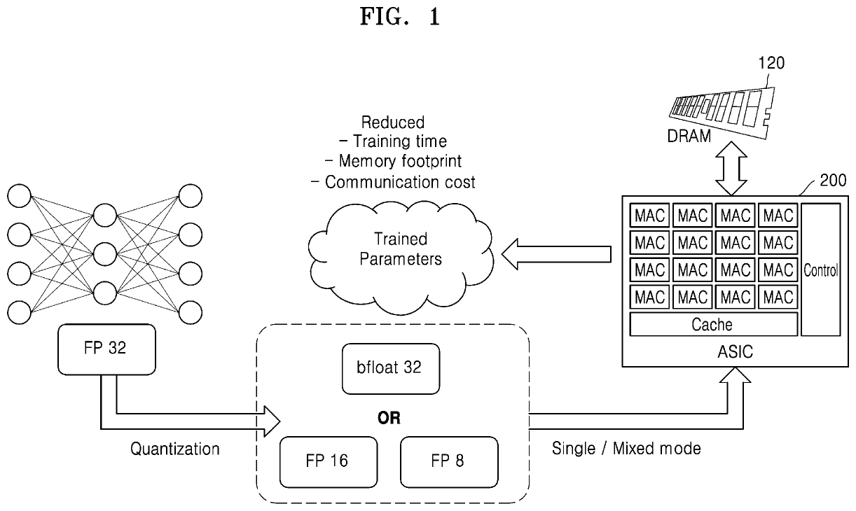

FIG. 1 is a diagram for describing a deep learning operating environment in the related art.

In the related art, a deep neural network is trained with a central processing unit (CPU) or a graphics processing unit (GPU). However, training of a deep neural network requires a large amount of computation, and CPUs have a small number of arithmetic and logical units (ALUs) and thus take a lot of time for the training. In addition, GPUs have a large number of ALUs, but have low applicability and thus are difficult to be applied to various training computations.

Therefore, in the disclosure, a hardware accelerator that is highly applicable and has many ALUs, and thus is faster and more flexible than a method using a GPU or a method using a CPU is described.

In addition, as illustrated in FIG. 1, in the related art, computations have been performed by using one precision, i.e., FP32, and in a case of using FP32 for all data, a large-capacity memory 120 is required, and a high communication cost occurs in a process of transmitting and receiving the data.

In a case in which a large-capacity memory and a high communication cost are required, it is difficult to train a deep neural network on a mobile device having low resources. In addition, various steps are included in a training process, and the precisions required for the respective steps may be different from each other. In the related art, only one precision is used in a training process, and thus the training process takes a long time, however, in the disclosure, faster training may be performed by adaptively varying the precision according to the required precision for each step of the training process. A detailed configuration and operation of a hardware accelerator 200 according to the disclosure will be described below.

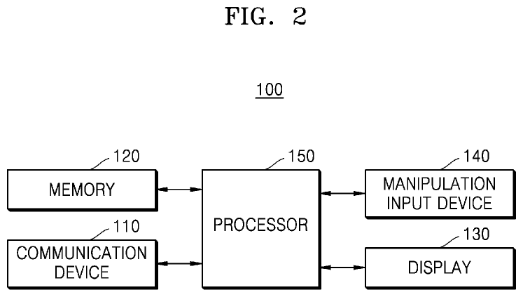

FIG. 2 is a block diagram illustrating a configuration of an electronic device 100 according to an embodiment.

Referring to FIG. 2, the electronic device 100 may include a communication device 110, the memory 120, a display 130, a manipulation input device 140, and a processor 150. Such an electronic device may be a mobile device such as a smart phone, as well as a device such as a personal computer (PC), a laptop computer, or a server.

The communication device 110 is provided to connect the electronic device 100 with an external device (not shown), through a local area network (LAN) and an Internet network, or through a Universal Serial Bus (USB) port or a wireless communication (e.g., Wi-Fi 802.11a/b/g/n, near-field communication (NFC), Bluetooth) port. The communication device 110 may also be referred to as a transceiver.

The communication device 110 may receive a deep neural network to be trained, and/or a data set for training the deep neural network.

In an embodiment, the communication device 110 may transmit a trained deep neural network to the outside, or may transmit a result value obtained by applying externally provided data to the deep neural network.

In an embodiment, the communication device 110 may receive, from the outside, a parameter required for training a deep neural network, for example, the size (or a precision) of a mantissa to be used in the training. Meanwhile, in an implementation, various parameters may be directly input from a user through the manipulation input device 140 to be described below.

The memory 120 may store at least one instruction related to the electronic device 100. In detail, various programs (or software) for operating the electronic device 100 according to various embodiments may be stored in the memory 120.

In an embodiment, the memory 120 may be implemented in various forms, such as random-access memory (RAM), read-only memory (ROM), flash memory, a hard disk drive (HDD), an external memory, or a memory card, but is not limited thereto.

In an embodiment, the memory 120 may store a deep neural network required for machine learning or deep learning. Here, the deep neural network may be a deep learning network, but is not limited thereto, and various models may be applied as long as the model may update internal weights thereof based on a data set.

The display 130 displays a user interface window for receiving a selection of a function supported by the electronic device 100. In detail, the display 130 may display a user interface window for receiving a selection of various functions provided by the electronic device 100. The display 130 may be a monitor such as a liquid-crystal display (LCD) or an organic light-emitting diode (OLED) display, and may be implemented as a touch screen capable of simultaneously performing functions of the manipulation input device 140 to be described below.

The display 130 may display a message requesting input of various parameters to be applied to a training process. In an implementation, the parameters may be directly input by the user, or may be automatically selected according to the characteristics of the deep neural network and a data set.

The manipulation input device 140 may receive, from the user, a selection of a function of the electronic device 100 and a control command for the function.

The processor 150 controls the overall operation of the electronic device 100. In detail, the processor 150 may control the overall operation of the electronic device 100 by executing at least one instruction stored in the memory 120. The processor 150 may be a single device such as a CPU or an application-specific integrated circuit (ASIC), or may include a plurality of devices such as CPUs or CPUs.

When a command to train the deep neural network is input, the processor 150 may perform a training operation on the deep neural network by using an input data set. In this process, the processor 150 may perform the training operation by using an internal dedicated hardware accelerator. The hardware accelerator performs computations by using a block floating point (BFP) method, and may perform the computations with various precisions.

To this end, the processor 150 may convert data constituting the training data set into data having the same exponential size and a preset size of the sign and mantissa. Here, the preset size may be 4 bits, 8 bits, or 16 bits.

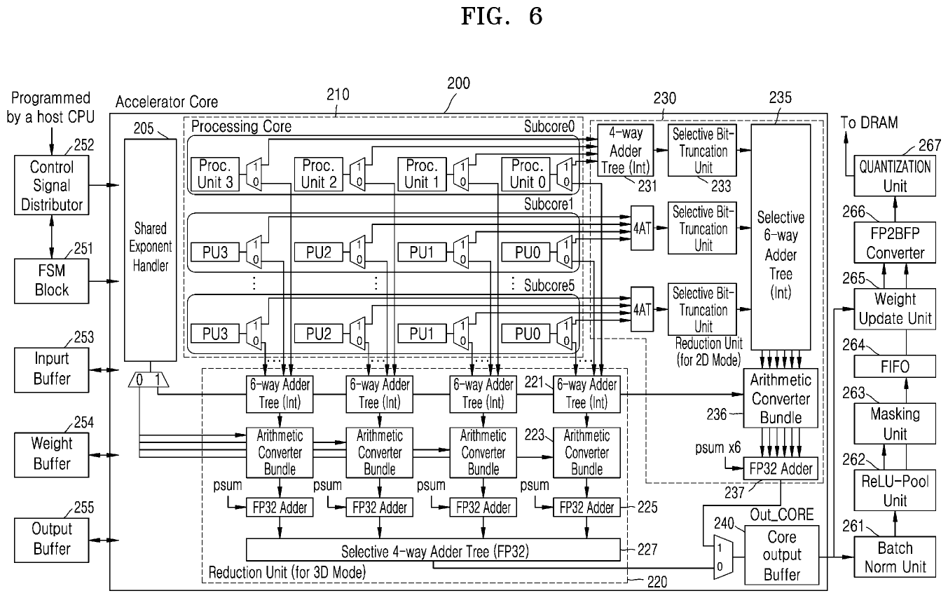

In this case, the hardware accelerator may perform arithmetic operations with different precisions during various processes of the deep neural network. In detail, the processor 150 may perform the training operation such that the data is converted to have a first size (e.g., 4 bits or 8 bits) in at least one of a forward pass step and a backward pass step, and to have a mantissa having a second size (e.g., 16 bits) greater than the first size in a weight update process. Also, in the weight update process, a loss gradient map may be divided into blocks of a preset size, and a computation operation may be performed in units of the blocks into which the loss gradient map is divided. A detailed operation of the hardware accelerator will be described below with reference to FIG. 6.

In an embodiment, the processor 150 may generate a control signal for controlling the hardware accelerator and provide the generated control signal to the hardware accelerator. Here, the control signal may include information such as network type, number of layers, dimensionality of data, rectified linear unit (ReLU), or pooling options.

As described above, the electronic device 100 according to the disclosure performs training or inference by using a dedicated hardware accelerator used for training or inference of a deep neural network, and thus may quickly perform a training or inference operation. In addition, a training process is performed by using a precision suitable for each step in the training process, rather than using a fixed precision, it is possible to perform training with flexibility and high precision.

Meanwhile, although the hardware accelerator is described above as a component within the processor 150, the hardware accelerator may be a separate component from the processor 150 in an implementation. In addition, although it is illustrated and described above with reference to FIG. 2 that the operation is applied to only a process of training a deep neural network, the operation may also be applied to an inference process using the training deep neural network in an implementation.

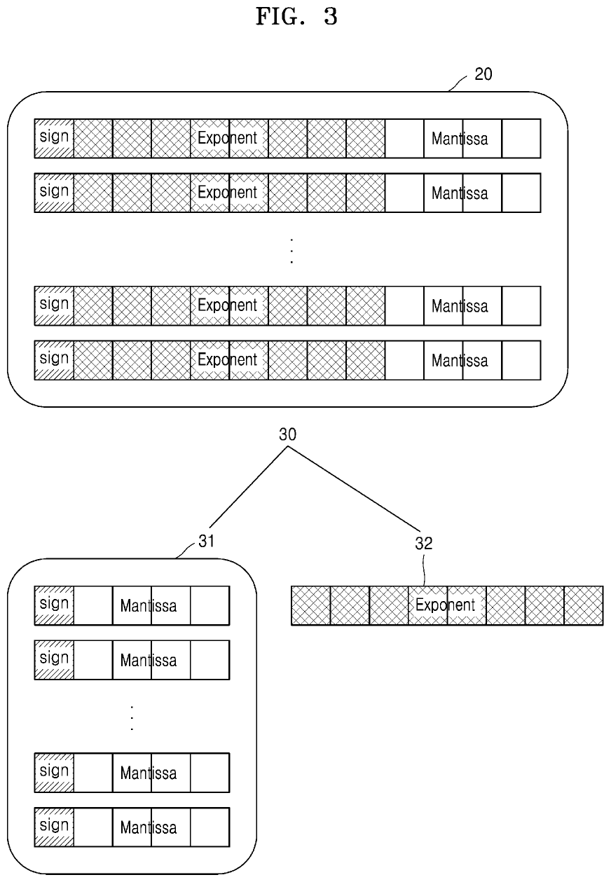

FIG. 3 is a diagram for describing BFP according to an embodiment.

In the disclosure, computations are performed by using a BFP method. Before describing the BFP method, a general method of representing a floating-point number will be described.

Floating-point numbers may have various forms depending on precision, but the most used is FP32 20, which is a format specified by the Institute of Electrical and Electronics Engineers (IEEE). The FP32 20 represents a real number with a sign, an exponent, and a mantissa. For example, a floating-point number may be expressed as Equation 1 below.

xᵢ=(−1)^{S}^{ᵢ}·mᵢ·2^{e}^{ᵢ} [Equation 1]

Here, Xᵢ denotes a real number, sᵢ denotes a sign, mᵢ denotes a mantissa, and eᵢ denotes an exponent for the real number.

Meanwhile, in the FP32 20, the sign is indicated with 1 bit, the mantissa is indicated with 23 bits, and the exponent is indicated with 8 bits, such that the floating-point number is indicated with a total of 32 bits.

However, in a case of processing data with 32 bits for all values, many resources may be wasted in the processing. Accordingly, in the disclosure, the concept of BFP is introduced to represent various pieces of data with the same exponent.

In detail, BFP 30 is a special form of the floating-point representation described above, and each number shares an exponent 32 of the highest number among N number blocks. That is, as illustrated on the right side of FIG. 3, several values have the same shared exponent 32, and each value 31 has only a sign and a mantissa for the corresponding shared exponent. For example, a plurality of real values may be expressed as Equation 2 below.

\vec{x}=[x₁,x₂, . . . ,x_{N}]=[ [symbol] , [symbol] , . . . , [symbol] ]·2^{e}^{ₛ}=\hat{\vec{x}}·2es [Equation 2]

Here, es denotes the shared exponent of the block, and is eₛ=└log₂(max(|x₁|, . . . , |x_{N}|))┘.In an embodiment, each value consists of only a sign and a mantissa as shown in Equation 3 below.

[symbol]

={Sᵢ,mᵢ} [Equation 3]

By using BFP as describing above, not only may a data storage space be greatly reduced, but also real-number computations may be performed with only integer arithmetic operations.

In addition, various sizes of sign and mantissa are supported according to precision. For example, the sizes of the sign and mantissa may be 4 bits, 8 bits, or 16 bits. In an embodiment, the size of the sign and mantissa may be applied differently for each step in the training process. For example, a 4-bit sign and mantissa may be used for a feature map computation, and an 8-bit or 16-bit sign and mantissa may be used for a local gradient computation or weight update.

As such, the disclosure supports mantissas of various sizes, and thus models generated according to the present disclosure may be executed on an accelerator that supports a CPU/GPU with a precision (e.g., bfloat 16) using the same exponent bits. In addition, by controlling a handler that manages the exponent, it is possible to perform 4-bit, 8-bit, and 16-bit integer arithmetic operations. This will be described below with reference to FIG. 6.

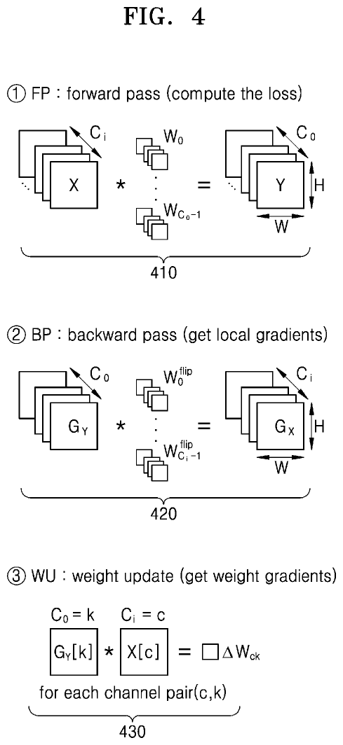

FIG. 4 is a diagram for describing major operations of a process of training a deep neural network, according to an embodiment. Referring to FIG. 4, the training process includes three major computational operations as illustrated in FIG. 4.

The first operation is a training loss computation operation 410, which may also be referred to as a forward pass. The training loss computation operation is an operation of computing an output feature map Y by performing a convolution operation on an input feature map X with sets W₀, W_{co-1} of weight kernels. The number of channels of the input feature map X may be Cᵢ, and the number of channels of the output feature map Y may be Cₒ. The number of sets W₀, W_{c-1} of weight kernels may be Cₒ. The width and height of the output feature map Y may be W and H, respectively. In an embodiment, the width and height of the input feature map X and the width W and height H of the output feature map Y may be different from each other, respectively. In an embodiment, the width and height of the input feature map X and the width W and height H of the output feature map Y may be identical to each other, respectively. In this case, zero padding may be performed in the convolution operation on the input feature map X with the sets W₀, W_{Co-1} of weight kernels. When the training loss computation operation is performed, a total loss [symbol] for a mini-batch may be computed. In the disclosure, an input feature map may also be referred to as an input tensor, and a weight kernel may also be referred to as a weight tensor.

The second operation is a local gradient operation 420, which may also be referred to as a backward pass. The local gradient operation is an operation of propagating a loss to each layer in the network. In this operation, a convolution operation with sets W₀^{flip}, . . . , W_{c}_{ᵢ}₋₁^{flip} of transposed weight kernels is performed, and a local gradient G_{Y}=∂ [symbol] /∂Y in each layer (e.g., an l-th layer) is input. An output in this process is a local gradient Gₓ=∂ [symbol] /∂X in a layer (e.g., an I-1st layer).

The final operation is a weight gradient computation operation 430, which may also be referred to as weight update. In the weight gradient computation operation, an convolution operation is performed on a local gradient with an input map in each layer, and weight gradients may be used to update the weights. For example, for a channel pair (c, k) including the c-th channel of Cᵢ and the k-th channel of Cₒ, a convolution operation may be performed on a local gradient C_{Y}[k] and an input feature map X[c] corresponding to the channel pair (c, k), and an output in this process may be a weight gradient ΔW_{ck}.

It may be seen that such a deep learning process is performed with a process of computing a loss and transferring the computed loss, and the convolution operation is the major operation in each step.

Meanwhile, among the above-described operations, values are not accumulated and used in the processing of the weight update operation, but values are accumulated and used in the forward pass and the backward pass processes.

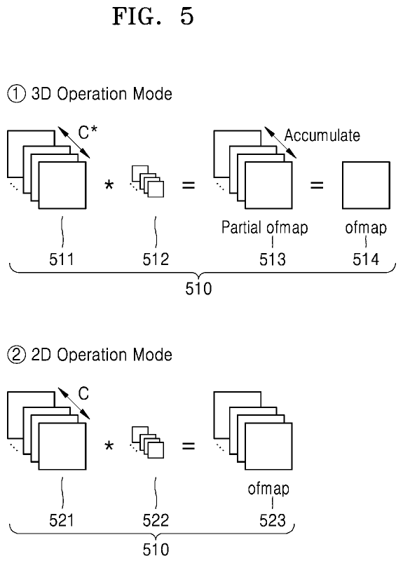

However, in a case in which a cumulative value is computed in all processes, a delay may occur or efficiency may decrease in the computations, and thus, in the disclosure, the computed values are processed in different ways for the respective steps of the deep neural network computations. This will be described below with reference to FIG. 5.

FIG. 5 is a diagram for describing a two-dimensional (2D) operation mode and a three-dimensional (3D) operation mode, according to an embodiment.

The 3D operation mode 510 requires an operation of outputting an output feature map 514 by accumulating, in a channel direction, partial output feature maps 513 obtained by performing a convolution operation (511*512). The 2D operation mode 520 does not require an operation of accumulating, in a channel direction, output feature maps 523 obtained by performing a convolution operation (521*522). The operations in each mode is shown in Table 1 below.

TABLE 1

| Modes | Operations |
|---|---|
| 2 D | Computing ∂ [symbol] /∂W, Depthwise Conv, |
| | Dilated Conv, Up Conv |
| 3 D | General Conv, Pointwise Conv, FC |
| | (for both forward and backward pass) |

Referring to Table 1, in a case of performing a weight gradient computation, depthwise (DW) convolution, dilated convolution, or up convolution in training a deep neural network, a hardware accelerator may operate in the 2D operation mode. In addition, in a case of performing (general) convolution, pointwise convolution, or fully-connected layer computation in which results of computation are accumulated is performed in training a deep neural network, the hardware accelerator may operate in the 3D operation mode. As described above, in the disclosure, it is determined whether the 3D operation mode or the 2D operation mode is required in each step of computations of a deep neural network, and accumulation of results of parallelism is selectively performed and then output according to a result of the determining. A detailed configuration for such an operation will be described below with reference to FIG. 6.

Meanwhile, the disclosure aims to support various precisions in a process of training or inference a deep neural network. Previously, architectures with various precisions have been proposed. However, in the existing methods, the utilization of a plurality of computing cores (specifically, multiply-accumulate (MAC) units) changes according to a change in precision. For example, BitFusion is an architecture that supports various precisions including 16-bit (the size of the sign and mantissa), 8-bit, and 4-bit precisions, and in a case of operating with a 8-bit precision, the utilization is reduced by approximately 13.8% compared to a case of operating with a 16-bit precision, and in a case of operating with a 4-bit precision, the utilization is further reduced by approximately 22% compared to a case of operating with a 16-bit precision.

In this regard, the disclosure aims to support various precisions while operating a plurality of computing cores with high utilization in each precision.

A detail hardware configuration for achieving this purpose will be described below with reference to FIG. 6.

FIG. 6 is a diagram for describing a configuration of a hardware accelerator according to an embodiment.

Referring to FIG. 6, the hardware accelerator 200 includes an accelerator core and a plurality of functional blocks 251 to 267. The hardware accelerator 200 may be implemented as a hardware component such as an ASIC.

The accelerator core may include a processing core 210, a first processing device 230, a second processing device 220, and a core output buffer 240. The first processing device 230 and the second processing device 220 may also be referred to as reduction units as illustrated in FIG. 6.

The processing core 210 may perform a convolution operation or a general matrix multiply (GEMM) operation. In detail, the processing core 210 may be hierarchically configured with a plurality of multipliers (or multiplication units) capable of performing 1D sub-word parallelism. The processing core 210 may include a plurality of multipliers that perform 1D sub-word parallelism between the sign and mantissa of a first tensor and the sign and mantissa of a second tensor. For convenience of description, the following descriptions are made on the assumption that the first tensor is an input tensor and the second tensor is a weight tensor, but the disclosure is not limited thereto.

In an embodiment, the size of the shared exponent of the first tensor and the size of the shared exponent of the second tensor may be 8 bits. The size of the sign and mantissa of the first tensor or the size of the sign and mantissa of the second tensor may be one of 4 bits, 8 bits, and 16 bits. Based on the size of the sign and mantissa of the first tensor or the size of the sign and mantissa of the second tensor, the first tensor and the second tensor may be mapped to the processing core 210.

In an embodiment, the size of the sign and mantissa of the first tensor or the size of the sign and mantissa of the second tensor may be determined based on the forward pass step, the backward pass step, or the weight update step of the training of the deep neural network.

In an embodiment, the processing core 210 consists of only integer multipliers and adders, and has a hierarchical structure, for example, multiplier→processing element (PE) (or processing engine)→processing unit (PU)→subcore→(processing) core. The processing core 210 may include a plurality of subcores, each of the subcores may include a plurality of PUs, and each of the PUs may include a plurality of PEs. Each of the PEs may include a plurality of multipliers. Although FIG. 6 illustrates that the processing core 210 includes six subcores, each of the subcores includes four PUs, each of the PUs includes four PEs (or processing engines), and each of the PEs includes nine multipliers, this is an example, and the disclosure is not limited thereto. For convenience of description, an example of the configuration, function, and operation of the processing core 210 illustrated in FIG. 6 will be described.

In an embodiment, a first group of the plurality of multipliers may perform a multiplication operation between first sub-words among a series of sub-words of a first value included in a first tensor (e.g., an input tensor) and a series of sub-words of a second value included in a second tensor (e.g., a weight tensor). A second group of the plurality of multipliers may perform a multiplication operation between second sub-words among the series of sub-words of the first value and the series of sub-words of the second value.

Meanwhile, the hardware accelerator 200 may support various forms of data types that share an exponent or do not have any exponent. That is, the processor may support a first data type of a fixed-point type, a second data type having only an integer, a third data type having a sign and an integer, and a fourth data type of a real-number type (i.e., BFP) that shares an exponent.

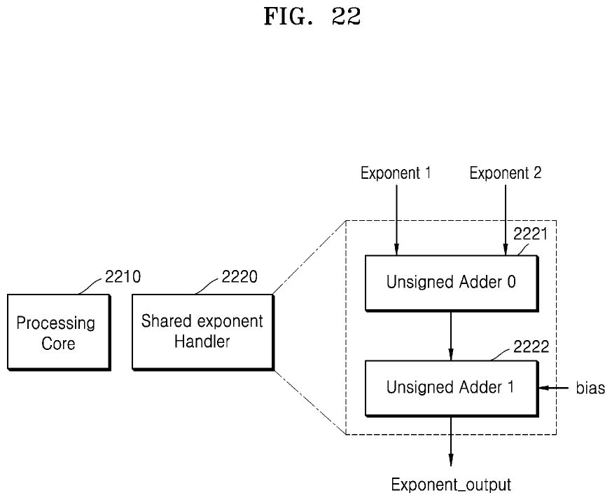

In an embodiment, the processing core 210 may perform a computation by using only significant figures (i.e., the sign and mantissa), and the exponent may be processed by a shared exponent handler 205. For example, the shared exponent handler may process a shared exponent of the first tensor (e.g., an input tensor) and a shared exponent of the second tensor (e.g., a weight tensor). A detailed configuration and operation of the shared exponent handler 205 will be described with reference to FIG. 22.

In a computation process, the mantissas of the input and weight tensors may be provided after being mapped to the subcores described above. For example, in a case in which the size of the mantissa is 8 bits rather than 16 bits, the number of input channels mapped to the processing core 210 may be twice as many as that in a case in which the size of the mantissa is 16 bits. For example, in a case of 4 bits, 4 times more input channels may be mapped than in a case of 16 bits. In an embodiment, as the size of a weight kernel increases, the number of input channels may proportionally decrease.

For example, in a computation of a Conv3 layer of the deep neural network, in a case in which the size of the sign and mantissa of the first tensor (e.g., an input tensor) is 16 bits, the first tensor corresponding to one input channel of the Conv3 layer may be broadcast to four PUs constituting one subcore.

In a case in which the size of the sign and mantissa of the first tensor is 8 bits, the first tensor corresponding to two input channels of the Conv3 layer may be broadcast to four PUs constituting one subcore.

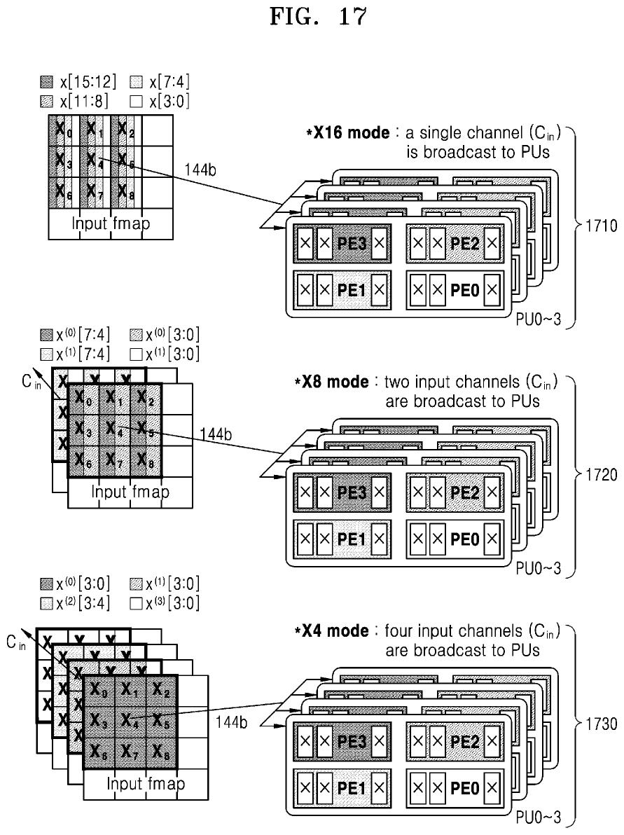

In a case in which the size of the sign and mantissa of the first tensor is 4 bits, the first tensor corresponding to four input channels of the Conv3 layer may be broadcast to four PUs constituting one subcore. The operation of the processing core 210 according to an embodiment will be described in detail with reference to FIG. 17.

In a case in which the deep neural network includes a convolutional layer having a weight kernel size larger than that of the Conv3 layer, a plurality of clustered subcores may process a single channel or multiple channels. For example, in a case of a Conv5 layer of a deep neural network, three subcores may process a single channel or multiple channels. In a case of a Conv7 layer of a deep neural network, six subcores may process a single channel or multiple channels. The number of channels processed according to data precision is the same as Conv3 described above.

As such, as the number of channels to be mapped varies according to the size of a sign and a mantissa and the size of a weight kernel, the operation may be performed with various combinations. A detailed operation according to various combinations will be described below.

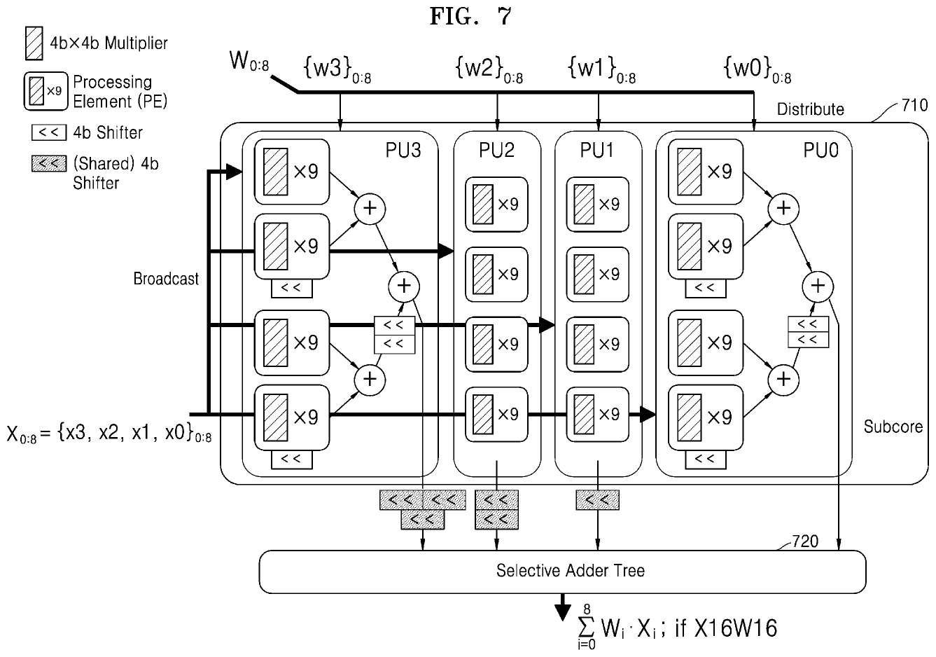

Although an example is illustrated and described in which the processing core includes six subcores and each subcore includes four PUs, in an implementation, the numbers of subcores and PUs of each subcore may be configured to have adaptive values according to the sizes of supported mantissas and the number of channels to be simultaneously processed. A detailed configuration of the subcores constituting the processing core will be described below with reference to FIG. 7.

The first processing device 230 is configured to output output maps of the processing core 210 without accumulating them in the channel direction when operating in the 2D operation mode. That is, the first processing device 230 may operate in the 2D operation mode in which results of computation by a plurality of multipliers are output without being accumulated in the channel direction. The first processing device 230 may include six 4-way adder trees 231, six bit truncators 233, a selective 6-way adder tree 235, an arithmetic converter 236, and an accumulator 237. However, the disclosure is not limited to the illustrated example, and for example, in a case in which the processing core 210 includes i subcores and each of the subcores includes j PUs, the first processing device 230 may be understood as including i j-way adder trees, i bit truncators, and a selective i-way adder tree.

Each of the six 4-way adder trees 231 may sum up outputs of four PUs within one subcore. Each of the six 4-way adder trees 231 corresponds to one of the six subcores, and may sum up outputs of four PUs included in each of the six subcores.

Each of the six bit truncators 233 may round off an output result of the corresponding 4-way adder tree 231 to have a preset number of bits. However, the disclosure is not limited thereto, and each of the six bit truncators 233 may round up or down an output result of the corresponding 4-way adder tree 231.

In an embodiment, the selective 6-way adder tree 235 may selectively sum up the outputs of a plurality of 4-way adder trees 231. In detail, the selective 6-way adder tree 235 may receive outputs of the bit truncators 233 and selectively accumulate or individually output the output results.

The arithmetic converter 236 may convert BFP to FP32. The arithmetic converter 236 may include at least one of a data type converter, a leading zero counter, a barrel shifter, and a normalizer. According to an embodiment, training accuracy may be preserved by performing batch normalization, which is sensitive to precision and data format, with a value obtained by converting to FP32. The arithmetic converter 236 may output 32-bit floating-point data (i.e., FP32 partial sum data) based on an exponential operation result output by the shared exponent handler 205 and a sign and mantissa operation result output by the selective 6-way adder tree 235.

In an embodiment, the accumulator 237 may accumulate values obtained by converting to FP32. The accumulator 237 may also be referred to as an FP32 adder as illustrated in FIG. 6. The accumulated values may be stored in a register (or a buffer). The accumulator 237 may add the values obtained by converting to FP32 and the accumulated value from the register (or the buffer). That is, the accumulator 237 may accumulate partial sums psums, which are values obtained by converting to FP32.

The second processing device 220 is configured to accumulate and output output maps of the processing core 210 in the channel direction when operating in the 3D operation mode. That is, the second processing device 220 may operate in the 3D operation mode in which results of computation by a plurality of multipliers are accumulated in the channel direction and then output. The second processing device 220 may include four 6-way adder trees 221, six arithmetic converters 223, six accumulators 225, and a selective 4-way adder tree 227. However, the disclosure is not limited to the illustrated example, and for example, in a case in which the processing core 210 includes i subcores and each of the subcores includes j PUs, the second processing device 220 may be understood as including j i-way adder trees, j arithmetic converters, j accumulators, and a selective j-way adder tree.

Each of a plurality of 6-way adder trees 221 sums up outputs of PUs corresponding to each other in different subcores. For example, each of the subcores may include first to fourth PUs. In this case, a first 6-way adder tree may sum up outputs of the first processing units of the subcores, a second 6-way adder tree may sum up outputs of the second PUs of the subcores, a third 6-way adder tree may sum up outputs of the third PUs of the subcores, and a fourth 6-way adder tree may sum up outputs of the fourth PUs of the subcores. In detail, because the subcores have different input channels, a summation operation needs to be performed in the channel direction when operating in the 3D operation mode. To this end, the 6-way adder trees 221 may receive outputs from the corresponding PUs within a plurality of subcores and then perform the summation operation. Through this process, the summation operation may be performed in the channel direction.

A plurality of arithmetic converters 223 may convert BFP to FP32. The plurality of arithmetic converters 223 may include at least one of a data type converter, a leading zero counter, a barrel shifter, and a normalizer. According to an embodiment, the plurality of arithmetic converters 223 perform batch normalization, which is sensitive to precision and data format, with values obtained by converting to FP32, and thus, training accuracy may be preserved. The plurality of arithmetic converters 223 may output 32-bit floating-point data (i.e., FP32 partial sum data) based on an exponential operation result output by the shared exponent handler 205 and sign and mantissa operation results output by the plurality of 6-way adder trees 221.

In an embodiment, the accumulators 225 may accumulate values obtained by converting to FP32. The accumulators 225 may also be referred to as FP32 adders as illustrated in FIG. 6. The accumulated values may be stored in a register (or a buffer). The accumulators 225 may add the values obtained by converting to FP32 and the accumulated value from the register (or the buffer). That is, the accumulators 225 may accumulate partial sums psums, which are values obtained by converting to FP32.

The selective 4-way adder tree 227 selectively sums up outputs of the respective accumulators 225 according to the precision mode.

The core output buffer 240 selectively outputs an output of the first processing device 230 or the second processing device 220. In detail, the core output buffer 240 may output an output value of the first processing device 230 in the weight update step, and output an output value of the second processing device 220 in the forward pass and backward pass steps.

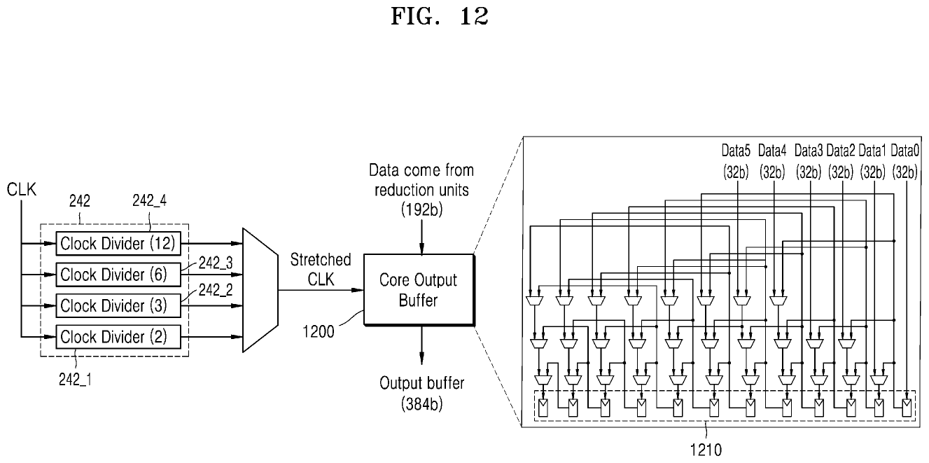

In an embodiment, the form (the number of words) of data output from the first processing device 230 or the second processing device 220 may depend on the operation mode, the precision, and the size of a weight kernel. However, because it is inefficient that subsequent modules perform adaptive operations according to each size, the core output buffer 240 may convert output data input thereto to have the same size, and then output a result of the converting. A detailed configuration and operation of the core output buffer 240 will be described below with reference to FIG. 12.

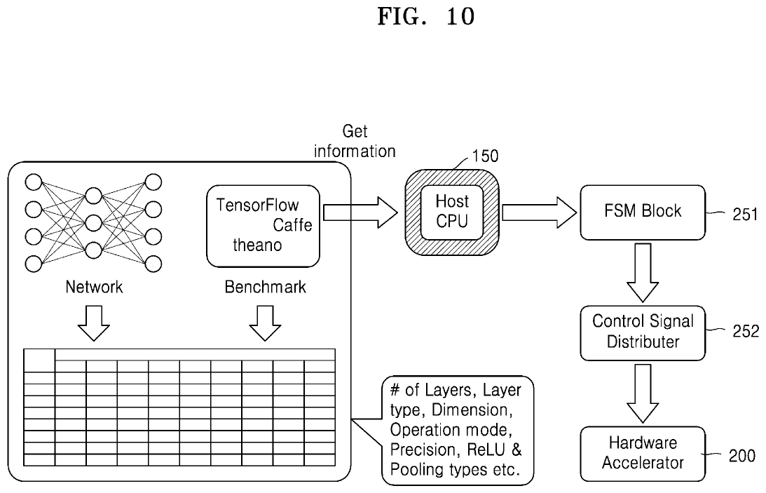

An FSM block 251 may receive a control signal from the processor 150 and optimize the received control signal according to an operation state of the processing core. In an embodiment, the optimized control signal may be distributed to each component through a control signal distributor 252. Detailed operations of the FSM block 251 and the control signal distributor 252 will be described below with reference to FIG. 10.

An input buffer 253 may serve as a receiver to receive an input feature map. The Input buffer 253 may transmit the input feature map to the processing core 210. A weight buffer 254 may serve as a receiver to receive a weight kernel. The weight buffer 254 may transmit the weight kernel to the processing core 210. An output buffer 255 may receive data output from the accelerator core. The output buffer 255 may transmit data output from an MAC operator to the outside.

Meanwhile, deep learning is largely composed of DNN layers and non-DNN layers. Deep learning accelerators in the past were designed to accelerate only computations of DNN layers because the amount of computation required in the DNN layers is considerable.

In recent years, the internal structures of deep learning networks have been changed and the amount of computation required in non-DNN layers has increased, and thus, it is required to be able to perform fast computations not only for DNN layers but also for non-DNN layers.

To this end, in the disclosure, a non-DNN layer accelerator (or an additional accelerator, a plurality of computing modules, and a plurality of functional blocks) is used. Such a non-DNN layer accelerator may include a batch normalization unit 261, a ReLU-pool unit 262, a masking unit 263, FIFO 264, a weight update unit 265, an FP2BFP converter 266, and a quantization unit 267. The batch normalization unit 261, the ReLU-pool unit 262, the masking unit 263, the FIFO 264, the weight update unit 265, the FP2BFP converter 266, and the quantization unit 267 may also be referred to as a batch normalization circuit, a ReLU-pool circuit, a masking circuit, a FIFO circuit, a weight update circuit, an FP2BFP converter circuit, and a quantization circuit, respectively.

Such a non-DNN layer accelerator may perform computations for a non-DNN layer. That is, a DNN layer of deep learning may process computations in the accelerator core described above, and other non-DNN layers may perform computations by using the plurality of computing modules described above.

Meanwhile, although the non-DNN layer accelerator arranged outside the accelerator core is described with reference to FIG. 6, it is also possible to arrange the non-DNN layer accelerator inside the accelerator core in an implementation. Meanwhile, in an implementation, the operations of the plurality of operation modules described above may be stopped and then only GEMM operations may be performed.

The batch normalization unit 261 performs batch normalization. The batch normalization unit 261 may perform batch normalization based on an output of the core output buffer 240. In detail, the batch normalization is a processing method used to seek weight parameters with faster convergence, and makes the training process more stable by reducing an internal covariant shift. In an embodiment, in order to update batch normalization parameters (e.g., an execution average or variance), it is generally necessary to read every input tensor from a memory three times, but in the disclosure, range batch normalization may be used. Accordingly, the number of memory accesses may be reduced by half compared to the related-art methods.

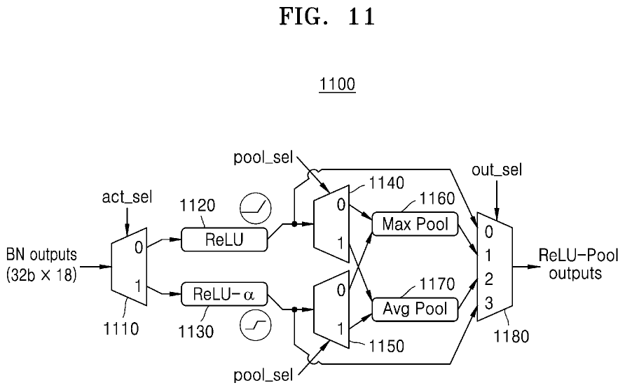

In general, a nonlinear activation function and a selective pooling layer are arranged subsequent to the batch normalization unit 261. However, because there may be no pooling layer between a batch normalization layer and a Cony layer, the flexible ReLU-pool unit 262 is used in the disclosure. The ReLU-pool unit 262 may perform a ReLU function value and a pooling value based on the output of the batch normalization unit 261. A detailed configuration and operation of the ReLU-pool unit 262 will be described below with reference to FIG. 11.

The masking unit 263 may be used in a backward pass process to minimize energy consumption of access to an unnecessary feature map (Fmap). For example, an output value of the backward pass of a ReLU layer has a value of 0 or 1. For example, when the input value of the forward pass is a positive number, the output value may have a value of ‘1’, and when the input value of the forward pass is a negative number, the output value may have a value of ‘0’. In the disclosure, in a case in which both ReLU and pooling layers exist, data may be stored more efficiently by fusing outputs of the ReLU and pooling layers in the backward pass rather than separately storing them.

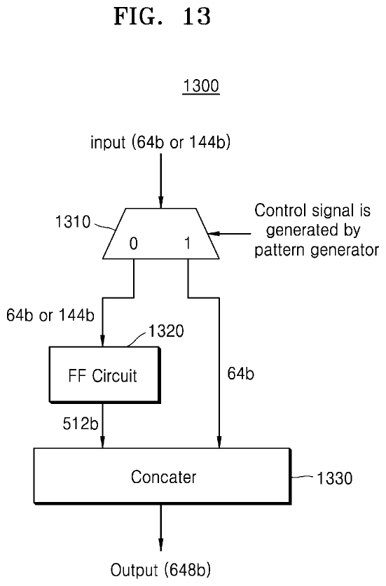

The FIFO 264 may store and output data of the ReLU-pool unit. A detailed configuration and operation of the FIFO 264 will be described below with reference to FIG. 13.

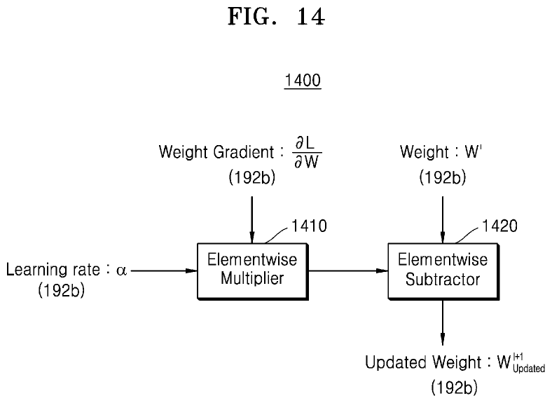

The weight update unit 265 may update the weights of the deep neural network. In detail, the weight update unit 265 may receive an input of weight gradients and a learning rate, and update each weight element in the deep neural network according to the input weight gradients and learning rate. The weight update unit 265 may be connected to the core output buffer 240 and the FIFO 264. A detailed configuration and operation of the weight update unit 265 will be described below with reference to FIG. 14.

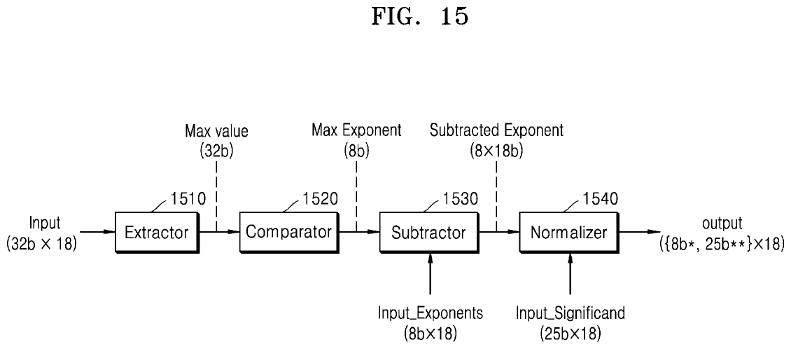

The FP2BFP converter 266 converts the data type of an output value and outputs a result of the converting. In detail, a MAC operation in the accelerator core is basically performed in a BFP manner. Accordingly, the FP2BFP converter 266 may convert floating point-type data (i.e., an output of the FIFO 264) to the type of the BFP 30. A detailed configuration and operation of the FP2BFP converter 266 will be described below with reference to FIG. 15.

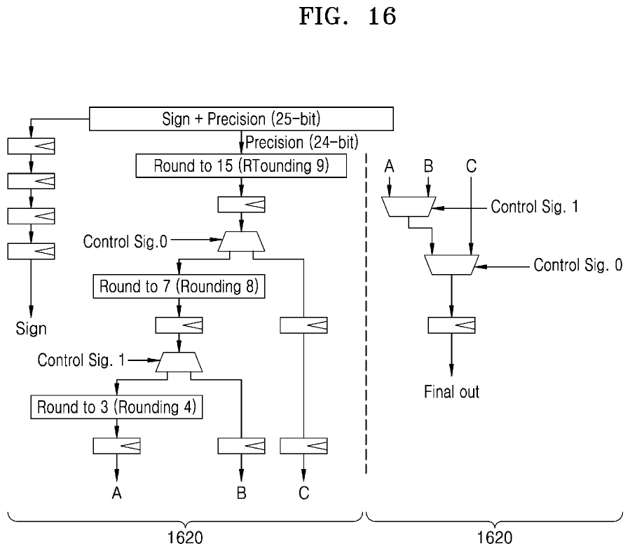

The quantization unit 267 quantizes an input value (i.e., an output of the FP2BFP converter 266) according to a predefined precision and outputs the quantized value. In detail, in the disclosure, BFP24, BFP16, and BFP12 are supported. BFP24, BFP16, and BFP12 have effective lengths of 16 bits, 8 bits, and 4 bits, respectively, and thus an input value may be rounded off to fit each effective length. A detailed configuration and operation of the quantization unit 267 will be described below with reference to FIG. 16.

Meanwhile, it is illustrated in FIG. 6 and described that the processing core is included in the processor, and thus, each of the above-described components may be implemented as a higher concept. That is, the above-described accelerator core may be implemented as a device such as an electronic device, and the processing core 210 may be implemented as a processor.

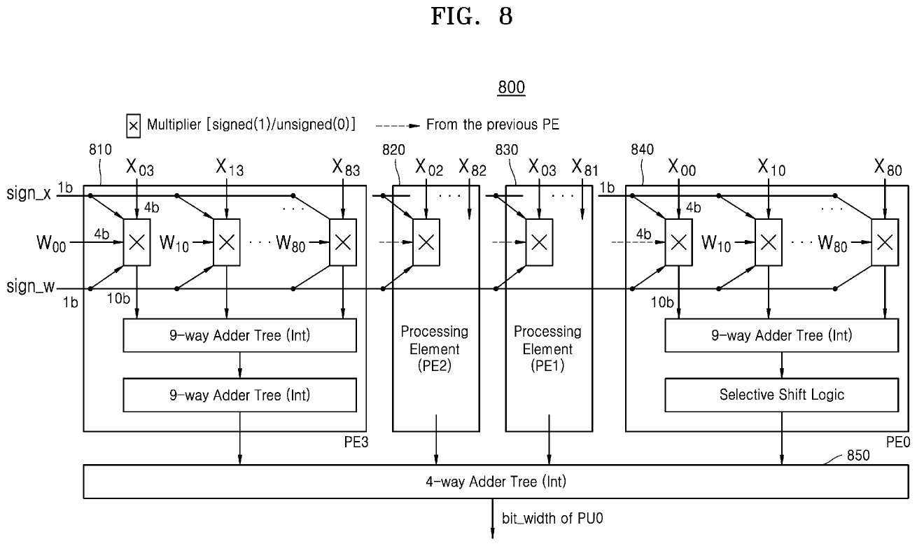

FIG. 7 is a diagram for describing the configuration of the subcore illustrated in FIG. 6, and FIG. 8 is a diagram for describing a detailed configuration of a processing unit illustrated in FIG. 7. It is assumed that the precisions of the ‘signs and mantissas’ of an input tensor X and a weight tensor W is 16 bits for convenience of description, but the disclosure is not limited thereto. It is assumed that the size of the weight tensor W, which is a weight kernel, is 3×3, but the disclosure is not limited thereto.

Referring to FIGS. 7 and 8, a subcore 710 may include a plurality of PUs (e.g., PU3, PU2, PU1, and PU0). As in the illustrated example, the number of PUs may be four, but the disclosure is not limited thereto. In an embodiment, each of the PUs may include a plurality of PEs.

For example, each of the PUs may include four PEs 810, 820, 830, and 840. FIG. 8 illustrates an example under the assumption that a PU 800 is referred to as PU0 in FIG. 7. Outputs of the PEs 810, 820, 830, and 840 may be summed up by a 4-way adder tree 850. The 4-way adder tree 850 may output a sum value having a bit width of PU0.

In an embodiment, one PE may include nine multipliers, one 9-way adder tree, and selective shift logic. The 9-way adder tree may sum up outputs of the nine multipliers. The selective shift logic (or may be referred to as a selective shift logic circuit) may shift bits corresponding to the sum of values by a predetermined number of bits before the sum is transferred to the 4-way adder tree 850. In an embodiment, the multipliers constituting the PE may be Baugh-Wooley multipliers.

In an embodiment, nine multipliers are clustered into one cluster in each PE. Such PEs may perform sub-word parallelism on the input tensor X.

In detail, when a 16-bit input tensor X is input, the input tensor X is mapped to each PE in units of 4-bit sub-words. For example, each of elements X_{0.8} of the 16-bit input tensor X may include 4-bit sub-words x0, x1, x2, and x3. Each of the 4-bit sub-words x0, x1, x2, and x3 may be mapped to one of the four PEs included in each of the PUs PU0, PU1, PU2, and PU3.

In an embodiment, the weight tensor W may also be applied in parallel to the four PUs within the same subcore. For example, in a case of a 16-bit weight tensor W, only a first 4-bit sub-word w3 of each of elements W_{0.8} of the 16-bit weight tensor W is mapped to the fourth PU PU3, and the other sub-words are mapped to the other PUs. That is, the other sub-words w2, w1, and w0 may be transferred to the third PU PU2, the second PU PU1, and the first PU PU0, respectively. Outputs of the first to fourth PUs PU0, PU1, PU2, and PU3 may be selectively summed up by a selective adder tree 720.

By hierarchically using sub-word parallelism as described above, when a 2× decrease in precision occurs for each of X and W, the cumulative partial sum may be doubled.

The operation as described above is for a case in which the mantissa is 4 bits, and in a case in which the mantissa is 8 bits and 16 bits, or the precisions of the weights are different from each other, some of the above-described PEs and PUs may operate in conjunction with each other. This operation will be described below with reference to FIGS. 17 to 20.

Referring to FIGS. 6 to 8, the sub-cores may perform 1D sub-word parallelism on the weight tensor W, and the PUs may perform 1D sub-word parallelism on the input tensor X.

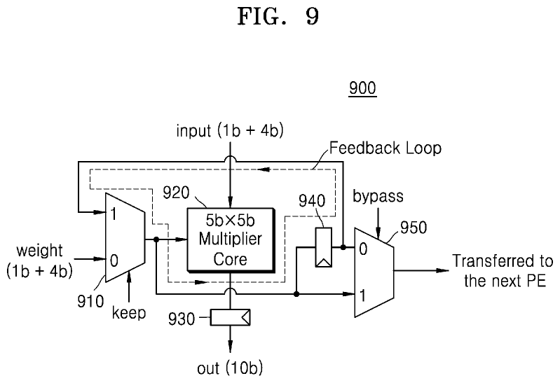

FIG. 9 is a diagram for describing a detailed configuration of the multiplier illustrated in FIG. 8. For convenience of description, it is assumed that the size of the weight tensor W, which is a weight kernel, is 3×3 or convenience of description, but the disclosure is not limited thereto.

Referring to FIG. 9, a PE according to the disclosure includes at least one multiplier. Such a multiplier supports both signed and unsigned operations. One global sign bit may be used to indicate whether an input or weight tensor is signed or unsigned. As the multiplier of the disclosure, a 5-bit multiplier is used. In detail, in the disclosure, various mantissa sizes are supported and the smallest unit of the supported mantissas has a 4-bit size, and thus, a multiplier capable of simultaneously processing the global sign bit and one mantissa was used.

Referring to FIG. 9 together with FIG. 8, nine multipliers included in the PE 810 may perform a signed operation or an unsigned operation by using a global sign bit sign_x of the input tensor and a global sign bit sign_w of the weight tensor. FIG. 8 illustrates that the precisions of the input tensor and the weight tensor are 16 bits, but in the disclosure, multiple precisions (e.g., 4 bits, 8 bits, and 16 bits) are supported for each of the input tensor and the weight tensor.

The nine multipliers included in the PE 810 may perform multiplication by using, as operands, 4-bit sub-words x03, x13, . . . , x83 having a first series of bits (e.g., [15:12]) of a 3×3 input tensor, and 4-bit sub-words w00, w10, . . . , w80 having a fourth series of bits (e.g., [3:0]) of a 3×3 weight tensor. For example, the multipliers may perform multiplication by using x03 and w00 as operands, perform multiplication by using x13 and w10 as operands, and similarly, perform multiplication by using x83 and w80 as operands.

The nine multipliers included in the PE 820 may perform multiplication by using, as operands, 4-bit sub-words x02, x12, . . . , x82 having a second series of bits (e.g., [11:8]) of the 3×3 input tensor, and the 4-bit sub-words w00, w10, . . . , w80 having the fourth series of bits (e.g., [3:0]) of the 3×3 weight tensor. Similarly, the nine multipliers included in the PE 830 may perform multiplication by using, as operands, 4-bit sub-words x01, x11, . . . , x81 having a third series of bits (e.g., [7:4]) of the 3×3 input tensor, and the 4-bit sub-words w00, w10, . . . , w80 having the fourth series of bits (e.g., [3:0]) of the 3×3 weight tensor. Similarly, the nine multipliers included in the PE 840 may perform multiplication by using, as operands, 4-bit sub-words x00, x10, . . . , x80 having a fourth series of bits (e.g., [3:0]) of the 3×3 input tensor, and the 4-bit sub-words w00, w10, . . . , w80 having the fourth series of bits (e.g., [3:0]) of the 3×3 weight tensor.

Referring back to FIG. 9, a multiplier 900 may include a first multiplexer (MUX) 910, a 5b×5b multiplier core 920, a first register 930, a second register 940, and a second MUX 950. The multiplier 900 may support a stationary dataflow capable of reusing data.

The first MUX 910 may receive a previous weight tensor through a first input terminal and a current weight tensor through a second input terminal. The first MUX 910 may output a current weight tensor or a previous weight tensor in response to a keep signal keep. For example, the first MUX 910 may output the previous weight tensor in response to a logic-high keep signal keep. On the contrary, the first MUX 910 may output the current weight tensor in response to a logic-low keep signal keep. However, the disclosure is not limited to the illustrated example, and the relationship between the logic value of the keep signal keep and the output of the first MUX 910 may be reversed. The first MUX 910 may include a plurality of switches or logic elements that are turned on/off in response to a plurality of signals.

The multiplier core 920 may perform a multiplication operation by using, as operands, a 5-bit input tensor and a 5-bit (current or previous) weight tensor. The multiplier core 920 may output a multiplication result value. The output value of the multiplier core 920 may be stored in the first register 930.

The weight tensor output by the first MUX 910 may be stored in the second register 940. The weight tensor stored in the second register 940 may be transferred to the first input terminal of the first MUX 910.

The second MUX 950 may receive the weight tensor stored in the second register 940 through a first input terminal, and receive the weight tensor output from the first MUX 910 through a second input terminal. The second MUX 950 may output the weight tensor stored in the second register 940 or the weight tensor output by the first MUX 910, in response to a bypass signal bypass. For example, the second MUX 950 may output the weight tensor output by the first MUX 910, in response to a logic-high bypass signal bypass. On the contrary, the second MUX 950 may output the weight tensor stored in the second register 940, in response to a logic-low bypass signal bypass. However, the disclosure is not limited to the illustrated example, and the relationship between the logic value of the bypass signal bypass and the output of the second MUX 950 may be reversed. The second MUX 950 may include a plurality of switches or logic elements that are turned on/off in response to a plurality of signals.

The weight tensor output by the second MUX 950 may be transferred to a PE (e.g., 820 of FIG. 8) next to the PE (e.g., 810 of FIG. 8) including the multiplier 900.

According to an embodiment, the weight tensor stored in the second register 940 may be kept through a feedback loop formed by the keep signal keep. According to an embodiment, at a 8-bit precision and a 16-bit precision, the number of cycles for loading data may be reduced by one cycle and two cycles, respectively. As the cycles for loading data is reduced, the number of times of fetching data from a memory may be reduced.

FIG. 10 is a diagram for describing an operation of the electronic device 100 according to an embodiment.

Referring to FIGS. 2 and 6 together with FIG. 10, the electronic device 100 includes the processor 150 (e.g., a host CPU), the FSM block 251, the control signal distributor 252, and the hardware accelerator 200.

The processor 150 may identify the network type, number of layers, dimensionality of data, precision, ReLU, and pooling options by analyzing a network, a data set, etc. used for training. In an embodiment, the processor 150 may generate a control signal for training.

The FSM block 251 checks the operation state of the hardware accelerator 200. In an embodiment, the FSM block 251 receives a control signal and optimizes the control signal based on the checked operation state of the hardware accelerator 200.

The FSM block 251 may provide the optimized control signal to each component in the hardware accelerator 200 by using the control signal distributor 252.

FIG. 11 is a diagram for describing a detailed configuration of the ReLU-pool unit 262 of FIG. 6. The configuration, function, and operation of the ReLU-pool unit 262 of FIG. 6 may correspond to the configuration, function, and operation of a ReLU-pool unit 1100. In detail, FIG. 11 is a diagram illustrating a configuration of the reconfigurable ReLU-pool unit 1100.

Referring to FIG. 11, the ReLU-pool unit 1100 may be reconfigured to output appropriate results for various cases of an activation function and a pooling layer.

For example, the activation function in the ReLU-pool unit 1100 may provide a ReLU and a ReLU-a. In an embodiment, the ReLU-pool unit 1100 may allow no pooling, maximum pooling, local average pooling, and global average pooling by controlling an ‘out_sel’ signal, for the pooling layer.

In an embodiment, the ReLU-pool unit 1100 may includes a first MUX 1110, ReLU logic 1120, ReLU-a logic 1130, a second MUX 1140, a third MUX 1150, max pooling logic 1160, average pooling logic 1170, and a fourth MUX 1180.

Referring to FIG. 6 together with FIG. 11, the first MUX 1110 may receive an output of the batch normalization unit 261 through an input terminal. The first MUX 1110 may output the output of the batch normalization unit 261 to the ReLU logic 1120 or the ReLU-a logic 1130 in response to an activation function selection signal act_sel. For example, the first MUX 1110 may output the output of the batch normalization unit 261 to the ReLU-a logic 1130 in response to a logic-high activation function selection signal act_sel. On the contrary, the first MUX 1110 may output the output of the batch normalization unit 261 to the ReLU logic 1120 in response to a logic-low activation function selection signal act_sel. However, the disclosure is not limited to the illustrated example, and the relationship between the logic value of the activation function selection signal act_sel and the output of the first MUX 1110 may be reversed. The first MUX 1110 may include a plurality of switches or logic elements that are turned on/off in response to a plurality of signals.

The ReLU logic 1120 may output a ReLU function value based on the output of the batch normalization unit 261. The ReLU logic 1120 may include a plurality of logic elements for implementing a ReLU function that outputs 0 when the input value is less than 0, and outputs the input value as it is when the input value is greater than or equal to 0.

The ReLU-a logic 1130 may output a ReLU-a function value based on the output of the batch normalization unit 261. The ReLU-a logic 1130 may include a plurality of logic elements for implementing a ReLU-a function that outputs 0 when the input value is less than 0, outputs the input value as it is when the input value is greater than or equal to 0 and less than a, and outputs a when the input value is greater than or equal to α. α may be a predefined value, and may be a training parameter. According to an embodiment, by using the ReLU-α function, it is possible to prevent an output value from being excessively large, and improve the accuracy of a quantized neural network.

Although FIG. 11 illustrates that the ReLU-pool unit 1100 includes only the ReLU logic 1120 and the ReLU-α logic 1130, the ReLU-pool unit 1100 may further include logic for implementing any activation function (e.g., sigmoid, tanh, leaky ReLU, parametric ReLU (PReLU), exponential linear unit (ELU), scaled exponential linear unit (SELU), etc.), and at least one of the ReLU logic 1120 and the ReLU-α logic 1130 may be omitted.

The second MUX 1140 may receive an output of the ReLU logic 1120 through an input terminal. The second MUX 1140 may output the output of the ReLU logic 1120 to the max pooling logic 1160 or the average pooling logic 1170 in response to a pooling selection signal pool_sel. For example, the second MUX 1140 may output the output of the ReLU logic 1120 to the average pooling logic 1170 in response to a logic-high pooling selection signal pool_sel. On the contrary, the second MUX 1140 may output the output of the ReLU logic 1120 to the max pooling logic 1160 in response to a logic-low pooling selection signal pool_sel. However, the disclosure is not limited to the illustrated example, and the relationship between the logic value of the pooling selection signal pool_sel and the output of the second MUX 1140 may be reversed. The second MUX 1140 may include a plurality of switches or logic elements that are turned on/off in response to a plurality of signals.

The third MUX 1150 may receive an output of the ReLU-α logic 1130 through an input terminal. The third MUX 1150 may output the output of the ReLU-α logic 1130 to the max pooling logic 1160 or the average pooling logic 1170 in response to a pooling selection signal pool_sel. For example, the third MUX 1150 may output the output of the ReLU-α logic 1130 to the average pooling logic 1170 in response to a logic-high pooling selection signal pool_sel. On the contrary, the third MUX 1150 may output the output of the ReLU-α logic 1130 to the max pooling logic 1160 in response to a logic-low pooling selection signal pool_sel. However, the disclosure is not limited to the illustrated example, and the relationship between the logic value of the pooling selection signal pool_sel and the output of the third MUX 1150 may be reversed. The third MUX 1150 may include a plurality of switches or logic elements that are turned on/off in response to a plurality of signals.

The max pooling logic 1160 may output a max pooling value based on the output of the ReLU logic 1120 or the output of the ReLU-α logic 1130. The max pooling logic 1160 may include a plurality of logic elements for implementing a max pooling layer that outputs a maximum value within a predefined region among a series of input values (e.g., an M×N map).

The average pooling logic 1170 may output an average pooling value based on the output of the ReLU logic 1120 or the output of the ReLU-α logic 1130. The average pooling logic 1170 may include a plurality of logic elements for implementing an average pooling layer that outputs an average value within a predefined region among a series of input values (e.g., an M× N map).

Although FIG. 11 illustrates that the ReLU-pool unit 1100 includes only the max pooling logic 1160 and the average pooling logic 1170, but the ReLU-pool unit 1100 may further include logic for implementing an any pooling layer or subsampling layer, and at least one of the max pooling logic 1160 and the average pooling logic 1170 may be omitted.

The fourth MUX 1180 may receive the output of the ReLU logic 1120 through a first input terminal, receive the output of the Max pooling logic 1160 through a second input terminal, receive the output of the average pooling logic 1170 through a third input terminal, and receive the output of the ReLU-α logic 1130 through a fourth input terminal. The fourth MUX 1180 may output the output of the ReLU logic 1120, the output of the max pooling logic 1160, the output of the average pooling logic 1170, or the output of the ReLU-α logic 1130, in response to an output selection signal out_sel. That is, the ReLU-pool unit 1100 may output the output of the ReLU logic 1120, the output of the max pooling logic 1160, the output of the average pooling logic 1170, or the output of the ReLU-α logic 1130, based on the output of the batch normalization unit 261.

FIG. 12 is a diagram for describing a detailed configuration of the core output buffer 240 of FIG. 6. The configuration, function, and operation of the core output buffer 240 of FIG. 6 may correspond to the configuration, function, and operation of a core output buffer 1200.

Referring to FIG. 12, the core output buffer 1200 may include 12 flip-flops (FFs) 1210. When all of the FFs 1210 are filled with data from the first processing device 230 (see FIG. 6) or the second processing device 220 (see FIG. 6), the core output buffer 1200 may output the data to the output buffer 255 (see FIG. 6).

The core output buffer 1200 may output data in response to a stretched clock signal Stretched CLK. A clock divider 242 may divide a clock signal CLK by n. Here, n is a natural number greater than or equal to 2. The clock divider 242 may divide the clock signal CLK at a preset division ratio. The clock divider 242 may include first to fourth clock dividers 242_1, 242_2, 242_3, and 242_4. For example, the first clock divider 242_1 may divide the clock signal CLK by 2. For example, the second clock divider 242_2 may divide the clock signal CLK by 3. For example, the third clock divider 242_3 may divide the clock signal CLK by 6. For example, the fourth clock divider 242_4 may divide the clock signal CLK by 12. However, the disclosure is not limited to that illustrated in FIG. 12, and the clock divider 242 may divide the clock signal CLK at various division ratios. A MUX 241 may receive clock signals obtained by the dividing and output the stretched clock signal Stretched CLK. The MUX 241 may output the stretched clock signal Stretched CLK in response to a control signal.

According to an embodiment, because the number of inputs to be filled in the FFs varies depending on circumstances, the time points at which the FFs are completely filled with data may be different from each other. Therefore, because it is necessary to output data at the right time, the clock divider 242 may be used to output the data stored in the FFs at the right time.

FIG. 13 is a diagram for describing a detailed configuration of the FIFO 264 of FIG. 6. The configuration, function and operation of the FIFO 264 of FIG. 6 may correspond to the configuration, function and operation of FIFO 1300.

Referring to FIG. 13, the FIFO 1300 may include a MUX 1310, a flip-flop circuit 1320, and a concater 1330. The FIFO 1300 may output bits of data in multiples of 18 for appropriate operation of subsequent logic (e.g., the FP2BFP converter 266 of FIG. 6) operating with multiples of 18 bits.

The MUX 1310 may receive 64-bit or 144-bit input data through an input terminal. In response to a control signal, the MUX 1310 may output the input data through a path through which data is transferred to the concater 1330 through the flip-flop circuit 1320 (i.e., a first path) or a path through which data is directly transferred to the concater 1330 (i.e., a second path). In an embodiment, the control signal may be generated by a pattern generator (not shown). Because the time point at which the FIFO 1300 outputs data varies depending on the mode (e.g., the 2D or 3D mode), the time point is controlled by using the pattern generator.

In an embodiment, the FIFO 1300 may fetch data to the flip-flop circuit 1320 and then fetch last data through another path. For example, in a case in which the pool size is 2, data is transferred to the flip-flop circuit 1320 for 8 cycles. Thereafter, the last data may be transferred directly to the concater 1330 through another path in the next cycle. The concater 1330 may concatenate data transferred through the first path and the second path. Because the time point at which the FIFO 1300 outputs data varies depending on the mode (e.g., the 2D or 3D mode), the time point is controlled by using the pattern generator (not shown).

FIG. 14 is a diagram for describing a detailed configuration of the weight update unit 265 of FIG. 6. The configuration, function, and operation of the weight update unit 265 of FIG. 6 may correspond to the configuration, function, and operation of a weight update unit 1400.

Referring to FIG. 14, the weight update unit 1400 may include an elementwise multiplication unit 1410 and an elementwise subtraction unit 1420.

The elementwise multiplication unit 1410 may include six multipliers. For example, the six multipliers may be FP32 multipliers. In detail, the elementwise multiplication unit 1410 may receive an input of six weight gradients

$$\frac{\partial L}{\partial {W}^{l}}$$

and a learning rate α, and compute update amounts for the weights.

The elementwise subtraction unit 1420 may include six adders/subtractors. In detail, the elementwise subtraction unit 1420 may receive an output of the elementwise multiplication unit 1410 and an input of a weight W^{ι}, and perform a weight update operation. For example, the elementwise subtraction unit 1420 may output an updated weight W_{updated}^{ι+1} by subtracting, from the weight W^{ι}, an output

$$α \cdot \frac{\partial L}{\partial {W}^{l}}$$

of the elementwise multiplication unit 1410.

FIG. 15 is a diagram for describing a detailed configuration of the FP2BFP converter 266 of FIG. 6. The configuration, function, and operation of the FP2BFP converter 266 of FIG. 6 may correspond to the configuration, function, and operation of a FP2BFP converter 1500.

Referring to FIG. 15, an FP2BFP converter 1500 may include an extractor 1510, a comparator 1520, a subtractor 1530, and a normalizer 1540.

The extractor 1510 seeks the maximum value among input values.

The comparator 1520 may compare maximum values extracted by the extractor 1510 with each other to seek the maximum exponent in a block unit (i.e., the exponent of a block tensor). The size of the block unit may vary depending on a BFP format (e.g., FB12, FB16, or FB24) and/or the type of layer (e.g., CONV1/FC, CONV3, CONV5, or CONV7).

The subtractor 1530 may include a plurality of subtractors, and each of the plurality of subtractors may correspond to the input values (e.g., 18 input values), respectively. The subtractor 1530 may subtract the exponent of each of the input values from the maximum exponent. That is, the subtractor 1530 may receive the maximum exponent extracted by the comparator 1520 and the exponents of the values in the block tensor, and then compute the exponent in the BFP format.

The normalizer 1540 may perform normalization based on the exponent computed by the subtractor 1530. Here, the normalization refers to converting a mantissa into the format of ‘1.xxx . . . ’. In detail, in order to compute the mantissa when converting into a BFP format, the normalizer 1540 may adjust an effective value (i.e., the mantissa) in response to a previously computed exponent by performing an operation of shifting significant figures by using a barrel shifter.

FIG. 16 is a diagram for describing a detailed configuration of the quantization unit 267 of FIG. 6.

Referring to FIG. 16, the quantization unit 267 may quantize an input value according to the mantissa size used. For example, in a case in which a 25-bit value is input, the mantissa according to the disclosure is 4 bits, 8 bits, or 16 bits, and thus, the quantization unit 267 may perform rounding according to the size of the precision (i.e., the mantissa) to be currently used. For example, the maximum size of the mantissa to be used is 16 bits, and thus, the quantization unit 267 may perform quantization to suit each precision by performing a rounding operation to leave only 15 bits (i.e., performing rounding at the 16th digit, and truncating below the rounded digit to leave only 15 bits), performing an additional rounding operation to leave only 8 bits in a case of 8 bits, and performing a rounding operation to additionally leave only 4 bits in a case of 4 bits (1610). In an embodiment, the quantization unit 267 may output one of three outputs (1620).

FIG. 17 is a diagram for exemplarily describing how an input tensor is mapped to the processing core 210 (see FIG. 6) in a Conv3 layer.

Referring to FIG. 17, in the disclosure, each of three (i.e., an input tensor, a weight tensor, and a weight gradient) precisions uses an 8-bit shared exponent, and the sizes of the sign and mantissa of the three precisions are 4 bits, 8 bits, 16 bits, respectively. Hereinafter, the precision having an 8-bit shared exponent and a size of the sign and mantissa of 4 bits is referred to as FB12, and the remaining two are referred to as FB16 and FB24, respectively.

As described above, in a case in which there are three types of mantissa sizes and three types of tensors (e.g., an 8-bit input, a 4-bit weight, and a 16-bit gradient), there may be 27 combinations. The operation of the processing core 210 (see FIG. 6) according to the disclosure in such various combinations will be described.

First, a case of FB24 (i.e., the size of the sign and mantissa is 16 bits) for the Conv3 layer, such as input activation (a forward pass) or a local gradient (a backward pass) will be first described.

Referring to 1710 of FIG. 17, in a 16-bit mode, each of elements constituting an input feature map (i.e., an input tensor) X includes four 4-bit sub-words, and each 4-bit sub-word is mapped to multipliers (e.g., 4b×4b multipliers) in corresponding PEs PE0, PE1, PE2, and PE3. For example, a 4-bit sub-word x[15:12] may be mapped to the fourth PE PE3. For example, a 4-bit sub-word x[11:8] may be mapped to the third PE PE2. For example, a 4-bit sub-word x[7:4] may be mapped to the second PE PE1. For example, a 4-bit sub-word x[3:0] may be mapped to the first PE PE0. In a single cycle, a single input channel of the input feature map X may be broadcast to all of the PUs PU0, PU1, PU2, and PU3.

Referring to 1720 of FIG. 17 (in a case in which the size of the sign and mantissa is 8 bits), in an 8-bit mode, each element constituting the input feature map X includes two 4-bit sub-words. In this case, two input channels of the input feature map X may be broadcast to the PUs PU0, PU1, PU2, and PU3. In detail, two 4-bit sub-words) x⁽⁰⁾[7:4] and) x⁽⁰⁾[3:0] of the first input channel and two 4-bit sub-words x(¹)[7:4] and x(¹)[3:0] of the second input channel are mapped to multipliers (e.g., 4b×4b multipliers) in the corresponding PEs PE0, PE1, PE2, and PE3, respectively. For example, the 4-bit sub-word) x⁽⁰⁾[7:4] may be mapped to the fourth PE PE3. For example, the 4-bit sub-word) x⁽⁰⁾[3:0] may be mapped to the third PE PE2. For example, the 4-bit sub-word x(¹)[7:4] may be mapped to the second PE PE1. For example, the 4-bit sub-word x(¹)[3:0] may be mapped to the first PE PE0. That is, each of the four PUs PU0, PU1, PU2, and PU3 constituting one subcore may process, in parallel, data corresponding to two input channels of the Conv3 layer.

Referring to 1730 of FIG. 17 (in a case in which the size of the sign and mantissa is 4 bits), in a 4-bit mode, each element constituting the input feature map X includes one 4-bit sub-word. In this case, four input channels of the input feature map X may be broadcast to the PUs PU0, PU1, PU2, and PU3. In detail, a 4-bit sub-word) x⁽⁰⁾[3:0] of the first input channel, a 4-bit sub-word x(¹)[3:0] of the second input channel, a 4-bit sub-word x(²)[3:0] of the third input channel, and a 4-bit sub-word x(³)[3:0] of the fourth input channel are mapped to multipliers (e.g., 4b×4b multipliers) in the corresponding PEs PE0, PE1, PE2, and PE3, respectively. For example, the 4-bit sub-word x⁰[3:0] may be mapped to the fourth PE PE3. For example, the 4-bit sub-word x(¹)[3:0] may be mapped to the third PE PE2. For example, the 4-bit sub-word x(²)[3:0] may be mapped to the second PE PE1. For example, the 4-bit sub-word x(³)[3:0] may be mapped to the first PE PE0. That is, each of the four PUs PU0, PU1, PU2, and PU3 constituting one subcore may process, in parallel, data corresponding to four input channels of the Conv3 layer.

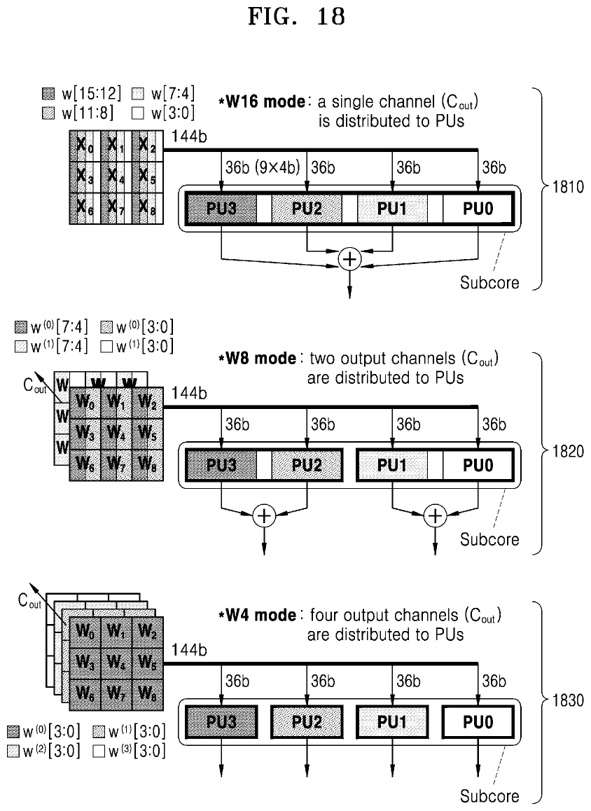

FIG. 18 is a diagram for exemplarily describing how a weight tensor is mapped to the processing core 210 (see FIG. 6) in a Conv3 layer.

Referring to 1810 of FIG. 18, in the 16-bit mode (i.e., the size of the sign and mantissa of the second tensor (e.g., a weight tensor) is 16 bits), a weight tensor corresponding to one output channel Cₒᵤₜ of the Conv3 layer may be distributed to four PUs constituting one subcore.

In detail, each of elements W₀, W₁, . . . , W₈ constituting the weight tensor W includes four 4-bit sub-words, and the 4-bit sub-words may be mapped to the corresponding PUs PU0, PU1, PU2, and PU3, respectively. For example, a first 4-bit sub-word w[15:12] of each of the elements W₀, W₁, . . . , W₈ of the weight tensor W may be mapped to the fourth PU PU3. For example, a second 4-bit sub-word w[11:8] of each of the elements W₀, W₁, . . . , W₈ of the weight tensor W may be mapped to the third PU PU2. For example, a third 4-bit sub-word w[7:4] of each of the elements W₀, W₁, . . . , W₈ of the weight tensor W may be mapped to the second PU PU1. For example, a fourth 4-bit sub-word w[3:0] of each of the elements W₀, W₁, . . . , W₈ of the weight tensor W may be mapped to the first PU PU0. That is, the total number of bits of the weight tensor W of a single channel composed of 16-bit elements is 144, and 36 bits may be distributed to each of the PUs PU3, PU2, PU1, and PU0.

Referring to 1820 of FIG. 18, in the 8-bit mode (i.e., the size of the sign and mantissa of the second tensor (e.g., a weight tensor) is 8 bits), a second tensor corresponding to two output channels Cₒᵤₜ of the Conv3 layer may be distributed to four PUs constituting one subcore.

In detail, it is possible to divide the four PUs PU3, PU2, PU1, and PU0 into two clusters and use them. For example, a first cluster may include the first PU PU0 and the second PU PU1, and a second cluster may include the third PU PU2 and the fourth PU PU3. Each of the elements W₀, W₁, . . . , W₈ constituting the weight tensor W includes two 4-bit sub-words, and each 4-bit sub-word may be mapped to the corresponding cluster. The two output channels Cₒᵤₜ of the weight tensor W may be mapped (or distributed) to the first cluster or the second cluster. For example, two 4-bit sub-words) w⁽⁰⁾[7:4] and) w⁽⁰⁾[3:0] of the first output channel may be mapped to the second cluster. For example, two 4-bit sub-words w⁽¹⁾[7:4] and w⁽¹⁾[3:0] of the second output channel may be mapped to the first cluster. Accordingly, each of the first PU PU0 and the second PU PU1 included in the first cluster may provide a partial sum for the second output channel, and each of the third PU PU2 and the fourth PU PU3 included in the second cluster may provide a partial sum for the first output channel. That is, the total number of bits of the weight tensor W having two output channels composed of 8-bit elements is 144, and 36 bits may be distributed to each of the PUs PU3, PU2, PU1, and PU0.

Referring to 1830 of FIG. 18, in the 4-bit mode (i.e., the size of the sign and mantissa of the second tensor (e.g., a weight tensor) is 4 bits), a second tensor corresponding to four output channels Cₒᵤₜ of the Conv3 layer may be distributed to four PUs constituting one subcore.

In detail, each of the four PUs PU3, PU2, PU1, and PU0 may correspond to one output channel. Each of the elements W₀, W₁, . . . , W₈ constituting the weight tensor W includes a single 4-bit sub-word, and the single 4-bit sub-word may correspond to one of the four output channels Cₒᵤₜ. For example, a 4-bit sub-word)w⁽⁰⁾[3:0] of the first output channel may be mapped to the fourth PU PU3. For example, a 4-bit sub-word w⁽¹⁾[3:0] of the second output channel may be mapped to the third PU PU2. For example, a 4-bit sub-word w⁽²⁾[3:0] of the third output channel may be mapped to the second PU PU1. For example, a 4-bit sub-word w⁽³⁾[3:0] of the fourth output channel may be mapped to the first PU PU0. That is, the total number of bits of the weight tensor W having four output channels composed of 4-bit elements is 144, and 36 bits may be distributed to each of the PUs PU3, PU2, PU1, and PU0.

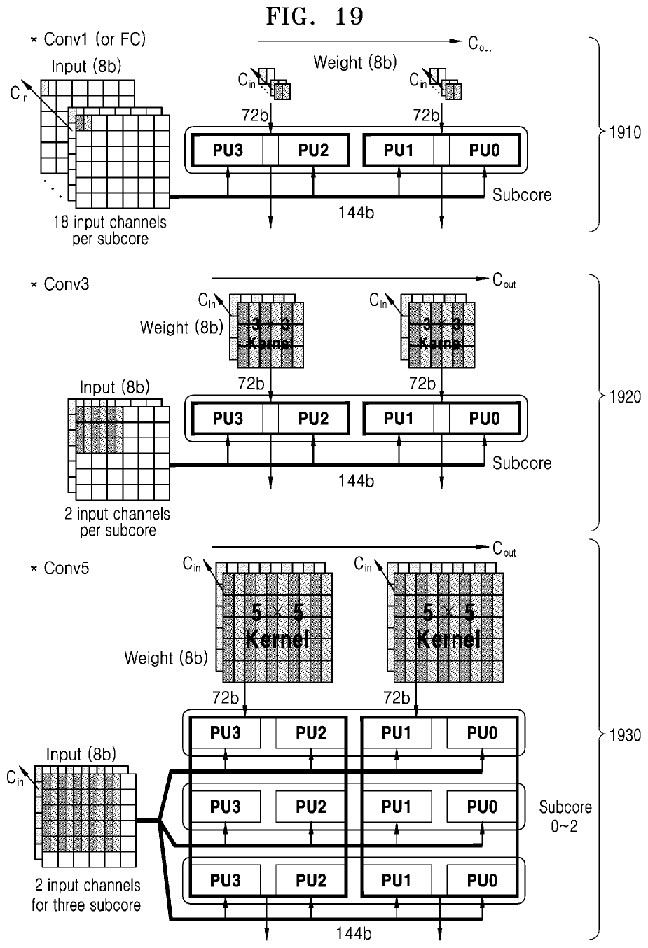

FIG. 19 is a diagram for describing an operation of a subcore according to a layer type of a deep neural network, according to an embodiment.

The hardware accelerator 200 (see FIG. 6) according to the disclosure is designed in a layer structure and may be managed differently according to the layer type. That is, it is possible to operate by clustering the above-described subcores or PEs according to the layer type of the deep neural network. Hereinafter, it is assumed that the precisions of an input tensor and a weight tensor are FB16 (i.e., the size of the sign and mantissa is 8 bits).

Referring to 1910 of FIG. 19, in a Conv1 or fully-connected layer, partial sums are accumulated only in the dimension of an input channel Cm. Accordingly, an input element (i.e., one of the elements of the input tensor) and a corresponding weight may be mapped to subcores, PEs and multipliers. For example, a plurality of input channels (e.g., 18 input channels) may be mapped to each subcore. For example, the first 18 input channels 0 to 17 may be mapped to a first subcore, and the next 18 input channels 17 to 35 may be mapped to a second subcore.

Referring to 1920 of FIG. 19, the difference between a Conv3 layer and the Conv1 or fully-connected layer illustrated in 1910 of FIG. 19 lies in the method of mapping operands to multipliers. In the Conv1 or fully-connected layer, a tensors (i.e. an operand) is mapped to a multiplier in the dimension of the input channel Cᵢₙ, whereas, in a Convk layer (e.g. a Conv3 layer), a tensor (i.e. an operand) may be mapped to a multiplier in the width and height (W/H) dimensions of a feature map. Here, k may be a natural number greater than 1.

In a case in which a larger weight kernel (e.g., a Conv5 layer, a Conv7 layer, etc.) is used, it is possible to cluster a plurality of subcores. Referring to 1930 of FIG. 19, for example, in a Conv5 layer, three subcores may be clustered. For example, in a Conv7 layer, six subcores can be clustered. According to an embodiment, in the Conv5 layer, three PEs each including nine multipliers are activated to perform 25 (5×5) multiplication operations, and thus, a core utilization of 93% (i.e. 5×5/9×3) may be achieved. According to an embodiment, in the Conv7 layer, six PEs each including nine multipliers are activated to perform 49 (7×7) multiplication operations, and thus, a core utilization of 91 (i.e. 7×7/6×9) may be achieved.

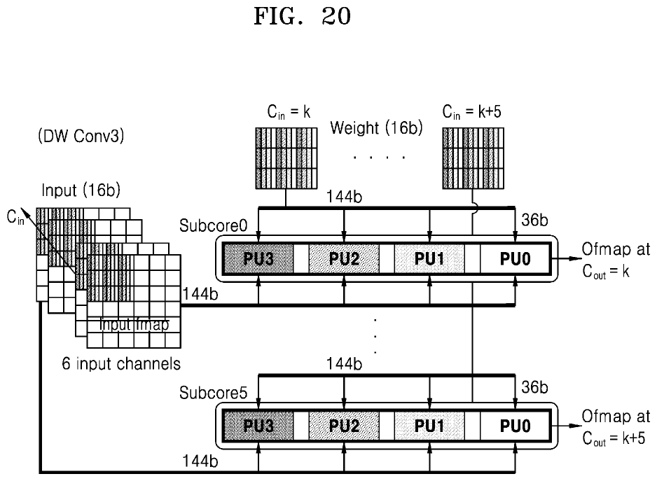

In the above, a mapping method for the 3D operation in which accumulation is performed by using the first processing device has been described. However, accumulation does not occur in the 2D operation, and because the hardware accelerator according to the disclosure has a separate processing device for 2D operation, the core utilization may be maximized. This will be described below with reference to FIG. 20.

FIG. 20 is a diagram for describing an example of a mapping method in a 2D operation mode, according to an embodiment. The 3D operation refers to an operation of outputting an output feature map by performing convolution and accumulating, in a channel direction, partial output feature maps, which are results of the convolution. The 2D operation refers to an operation of performing convolution without accumulating output feature maps with the channel direction.

A DW convolution layer is a good example of the 2D operation (which may be referred to as 2D computation or 2D processing). A method of mapping a DW Conv3 layer to a subcore will be described with reference to FIG. 20.

In the weight update step in the training process, computations are performed in a 2D manner, and because the computations are sensitive to a decrease in precision, it is preferable to maintain the precision to be 8 bits or 16 bits for each tensor.

Referring to FIG. 6 together with FIG. 20, outputs of the PUs PU0, PU1, PU2, and PU3 for each of subcores Subcore0, . . . , Subcore5 may be accumulated by the 4-way adder trees 231 of the first processing device 230. For example, in DW Conv3, an output from each of the subcores Subcore0, . . . , Subcore5 may correspond to one output channel Cₒᵤₜ of the output feature map.

In a case in which DW Conv5 or DW Conv7 is used, a plurality of subcores may be clustered and then used. For example, in the DW Conv5, three subcores may be clustered and then used, and in the DW Conv7, six subcores may be clustered and then used. A method of clustering subcores according to the size of a weight kernel may be similar to the method described with reference to 1930 of FIG. 19.

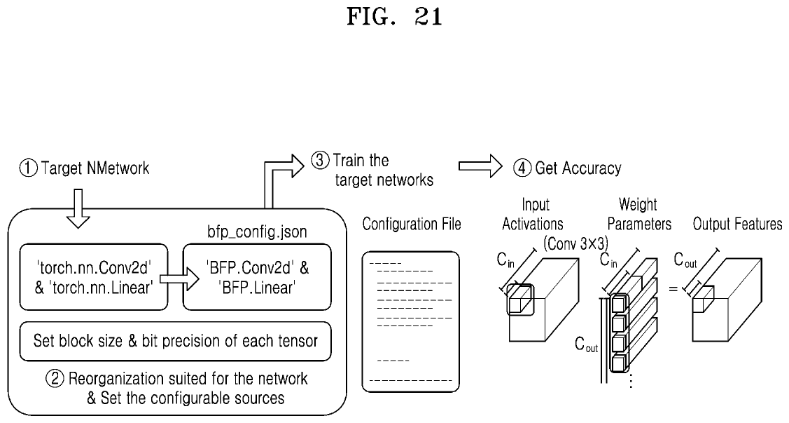

FIG. 21 is a diagram for describing an operation of an electronic device according to an embodiment.

Referring to FIG. 2 together with FIG. 21, the electronic device 100 may obtain parameters of a deep neural network. For example, the electronic device 100 may receive, from a user, an input of parameters of a target network (i.e., a deep neural network) to be trained. For example, the parameters of the deep neural network may be at least one parameter corresponding to the target network, such as block size, precision, or number of epochs.

The electronic device 100 may set a bit precision and a block size for each tensor (e.g., an input tensor or a weight tensor) based on the parameters. According to an embodiment, the electronic device 100 may control set values for weight gradients based on the parameters.

After the setting, the electronic device 100 may train the target network (i.e., a deep neural network) and output a training result (e.g., accuracy) according to the training. For example, it may be checked whether the training performance is good, according to the conditions of the hardware accelerator (e.g., block size, precision, and mapping method).

FIG. 22 is a diagram for describing a detailed configuration of the shared exponent handler of FIG. 6.

A multiplier unit proposed in BitFusion used multipliers capable of performing multiplication in units of 2b and exhibited a high utilization rate of multipliers for various precisions (2b, 4b, and 8b).

However, the multiplier unit supports only signed and unsigned integer data types. Because deep learning training needs to be performed with high precision, the multiplier unit cannot be used in deep learning training.

The hardware accelerator according to an embodiment aims to support deep learning inference as well as training with high efficiency, and thus supports a wide range of precision operations including high precision.

Meanwhile, the hardware accelerator separately processes significant figures (a sign and a mantissa) and an exponent in order to efficiently process a MAC operation. For example, an accelerator core may include a processing core 2210 and a shared exponent handler 2220. According to an embodiment, in a MAC operation, significant figures may be processed by the processing core 2210 and exponents may be processed by the shared exponent handler 2220.

The processing core 2210 of FIG. 22 may correspond to one of the subcores Subcore0, Subcore1, . . . , Subcore5 of FIG. 6. The processing core 2210 may include 144 multipliers supporting a plurality of precisions (e.g., 4b, 8b, and 16b). However, the number of multipliers is only an example and may be a number suitable for a system in an implementation.

The shared exponent handler 2220 is a module for exponential operations. The shared exponent handler 2220 may include an adder unit that performs exponential operations. For example, the shared exponent handler 2220 may include a first unsigned adder 2221 and a second unsigned adder 2222. The first unsigned adder 2221 may sum up two input exponents. The second unsigned adder 2222 may output a value obtained by subtracting (or adding) a bias from (or to) an output of the first unsigned adder 2221.

In a case of processing an operation between BFP data types (e.g., FB12, FB16, FB24, etc.) or fixed-point types, processing of exponents may be performed by turning on the adder unit, and in a case of processing integer-type data, processing of data types such as INT4, INT8, or INT16 may be performed by turning off the adder unit.

Meanwhile, because the disclosure supports the BFP data type, only one exponent processing module is required for every 144 multipliers.

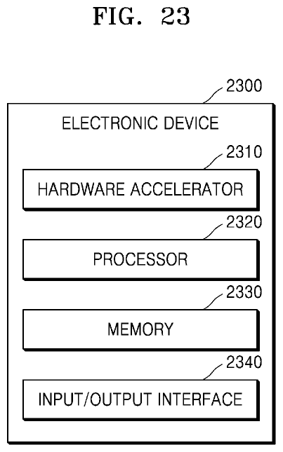

FIG. 23 is a block diagram exemplarily illustrating an electronic device 2300 according to an embodiment.

Referring to FIG. 23, the electronic device 2300 may include a hardware accelerator 2310, a processor 2320, a memory 2330, and an input/output interface 2340. However, the components of the electronic device 2300 are not limited to the above-described examples, and the electronic device 2300 may include more or fewer components than the above-described components. In an embodiment, at least some of the hardware accelerator 2310, the processor 2320, the memory 2330, and the input/output interface 2340 may be implemented as a single chip, and the processor 2320 may include one or more processors.

The configuration, function, and operation of the hardware accelerator 2310 may correspond to the configuration, function, and operation of the hardware accelerator 200 described with reference to FIG. 6. Thus, the descriptions provided above with reference to FIG. 6 will be omitted.

The hardware accelerator 2310 may perform 1D sub-word parallelism between the sign and mantissa of a first tensor (e.g., an input tensor) and the sign and mantissa of a second tensor (e.g., a weight tensor) by using a plurality of multipliers.

The hardware accelerator 2310 may perform processing between a shared exponent of the first tensor and a shared exponent of the second tensor by using a shared exponent handler.

The hardware accelerator 2310 may perform training or inference of a deep neural network, under control by the processor 2320. The hardware accelerator 2310 may read data (e.g., the first tensor and the second tensor) stored in the memory 2330 to perform computations. A result of computations by the hardware accelerator 2310 may be stored in the memory 2330.

In an embodiment, the hardware accelerator 2310 may operate in the 2D operation mode in which results of computation by a plurality of multipliers are output (without being accumulated in a channel direction), or in the 3D operation mode in which results of computation by the plurality of multipliers are accumulated in the channel direction and a result of accumulating the results of computation are output.

The processor 2320 is a component configured to control a series of processes such that the electronic device 2300 operates according to the embodiments described above with reference to FIGS. 1 to 22, and may include one or more processors. In this case, the one or more processors may be general-purpose processors, such as CPUs, application processors (APs), or digital signal processors (DSPs).

The processor 2320 may write data in the memory 2330 or read data stored in the memory 2330, and in particular, may execute a program stored in the memory 2330 to process data according to a predefined operation rule or an artificial intelligence model. In an embodiment, the processor 2320 may control the hardware accelerator, based on deep neural network information including at least one of the number of layers in the deep neural network, the types of layers, the shapes of tensors, the dimensionality of the tensors, the operation mode, a bit precision, the type of batch normalization, the type of a pooling layer, and the type of a ReLU function.

In an embodiment, the processor 2320 may obtain at least one of a bit precision and a block size of the deep neural network, based on a user input. The processor 2320 may set at least one of the bit precision and the block size of the first tensor and the second tensor based on at least one of the obtained bit precision and block size. The processor 2320 may control the hardware accelerator 2310 to train the deep neural network, based on the setting.

The hardware accelerator 2310 and the processor 2320 may perform the operations described above with reference to the embodiments, and the operations described above as being performed by the electronic device 2300 in the embodiments may be regarded as being performed by the hardware accelerator 2310 or the processor 2320 unless otherwise specified.

The memory 2330 is a component for storing various programs or data, and may include a storage medium, such as ROM, RAM, a hard disk, a compact disc ROM (CD-ROM), or a digital versatile disc (DVD), or a combination of storage media. The memory 2330 may not be separately provided but may be included in the processor 2320 or the hardware accelerator 2310. The memory 2330 may include a volatile memory, a nonvolatile memory, or a combination of a volatile memory and a nonvolatile memory. A program for the hardware accelerator 2310 or the processor 2320 to perform operations may be stored in the memory 2330. The memory 2330 may provide data stored therein to the hardware accelerator 2310 or the processor 2320 according to a request of the hardware accelerator 2310 or the processor 2320. In an embodiment, the memory 2330 may store at least one instruction to be executed by the processor 2320. The memory 2330 may store a deep neural network. The memory 2330 may store parameters or hyperparameters used to train a deep neural network or cause a deep neural network to perform inference.

The input/output interface 2340 may include an input interface (e.g., a touch screen, a hard button, or a microphone) for receiving a control command or information from a user, and an output interface (e.g., a display panel or a speaker) for displaying a result of executing an operation or a state of the electronic device 2300 according to control by the user. According to an embodiment, the input/output interface 2340 may receive a user input corresponding to at least one of the bit precision and the block size of a deep neural network.

In an embodiment, the hardware accelerator may include a plurality of multipliers that perform 1D sub-word parallelism between the sign and mantissa of a first tensor and the sign and mantissa of a second tensor. The hardware accelerator may include a first processing device that operates in the 2D operation mode for outputting results of computation by a plurality of multipliers. The hardware accelerator may include a second processing device that operates in the 3D operation mode for accumulating results of computation by a plurality of multipliers in a channel direction and outputting a result of accumulating the results of computation.

In an embodiment, a first group of the plurality of multipliers of the hardware accelerator may perform a multiplication operation between first sub-words among a series of sub-words of a first value included in a first tensor and a series of sub-words of a second value included in a second tensor. A second group of the plurality of multipliers of the hardware accelerator may perform a multiplication operation between second sub-words among the series of sub-words of the first value and the series of sub-words of the second value.

In an embodiment, in computations of a deep neural network, the hardware accelerator may operate in the 2D operation mode when performing a weight gradient computation, DW convolution, dilated convolution, or up convolution in which results of computations are not accumulated in the channel direction. In computations of the deep neural network, the hardware accelerator may operate in the 3D operation mode when performing convolution, pointwise convolution, or fully-connected layer computations in which results of computation are accumulated in the channel direction.

In an embodiment, a processing core may include six subcores. Each of the subcores may include 4 PUs. Each of the PUs may include four PEs. Each of the PEs may include nine multipliers.

In an embodiment, in a computation of a Conv3 layer of the deep neural network, in a case in which the size of the sign and mantissa of the first tensor is 16 bits, the first tensor corresponding to one input channel of the Conv3 layer may be broadcast to four PUs constituting one subcore. In a computation of a Conv3 layer of the deep neural network, in a case in which the size of the sign and mantissa of the first tensor is 8 bits, the first tensor corresponding to two input channels of the Conv3 layer may be broadcast to four PUs constituting one subcore. In a computation of a Conv3 layer of the deep neural network, in a case in which the size of the sign and mantissa of the first tensor is 4 bits, the first tensor corresponding to four input channels of the Conv3 layer may be broadcast to four PUs constituting one subcore.

In an embodiment, in a computation of a Conv3 layer of the deep neural network, in a case in which the size of the sign and mantissa of the second tensor is 16 bits, the second tensor corresponding to one output channel of the Conv3 layer may be distributed to four PUs constituting one subcore. In a computation of a Conv3 layer of the deep neural network, in a case in which the size of the sign and mantissa of the second tensor is 8 bits, the second tensor corresponding to two output channels of the Conv3 layer may be distributed to four PUs constituting one subcore. In a computation of a Conv3 layer of the deep neural network, in a case in which the size of the sign and mantissa of the second tensor is 4 bits, the second tensor corresponding to four output channels of the Conv3 layer may be distributed to four PUs constituting one subcore.

In an embodiment, the first processing device may include six 4-way adder trees that sum outputs of four PUs included in each of the six subcores. The first processing device may include six bit truncators that round off each of outputs of the 4-way adder trees to have a preset number of bits. The first processing device may include a selective 6-way adder tree that selectively sums outputs of the bit truncators. The first processing device may include an arithmetic converter that outputs FP32 partial sum data based on an output of the selective 6-way adder tree and an output of the shared exponent handler. The first processing device may include an accumulator that accumulates FP32 partial sum data.

In an embodiment, the second processing device may include four 6-way adder trees that sum up outputs of PUs corresponding to each other in different subcores. The second processing unit may include four arithmetic converters that output FP32 partial sum data based on outputs of the 6-way adder trees and the output of the shared exponent handler. The second processing unit may include four accumulators that accumulates FP32 partial sum data. The second processing unit may include a selective 4-way adder tree that selectively sums up outputs of the accumulators.

In an embodiment, each of the PUs may include nine multipliers that perform multiplication operations. Each of the PUs may include a 9-way adder tree that sums up outputs of the nine multipliers. Each of the PUs may include a selective shift logic circuit that shifts an output of the 9-way adder tree by a preset number of bits.

In an embodiment, the hardware accelerator may include a shared exponent handler that processes a shared exponent of the first tensor and a shared exponent of the second tensor.

In an embodiment, the hardware accelerator may perform computations by using numbers of data types corresponding to a control signal. In an embodiment, the data types may include a first data type of a fixed-point type, a second data type having only integers, a third data type having a sign and an integer, and a fourth data type of a real-number type sharing an exponent.

In an embodiment, the size of the shared exponent of the first tensor and the size of the shared exponent of the second tensor may be 8 bits. The size of the sign and mantissa of the first tensor or the size of the sign and mantissa of the second tensor may be one of 4 bits, 8 bits, and 16 bits. Based on the size of the sign and mantissa of the first tensor or the size of the sign and mantissa of the second tensor, the first tensor and the second tensor may be mapped to a processing core.

In an embodiment, the size of the sign and mantissa of the first tensor or the size of the sign and mantissa of the second tensor may be determined based on the forward pass step, the backward pass step, or the weight update step of the training of the deep neural network.

In an embodiment, the hardware accelerator may include a core output buffer that outputs an output value of the first processing device in the weight update step, and outputs an output value of the second processing device in the forward pass and backward pass steps.

In an embodiment, the hardware accelerator may include a batch normalization circuit that performs batch normalization based on an output of the core output buffer. The hardware accelerator may include a ReLU-pool circuit that performs a ReLU function value and a pooling value, based on an output of the batch normalization circuit. The hardware accelerator may include a FIFO circuit that stores and outputs an output of the ReLU-pool circuit. The hardware accelerator may include an FP2BFP converter circuit that converts the data type of an output of the FIFO circuit in a floating-point form into a BFP form. The hardware accelerator may include a quantization circuit that quantizes an output of the FP2BFP converter according to a predefined precision.

In an embodiment, each of the plurality of multipliers may include a first MUX that receives a previous second tensor through a first input terminal, receives a current second tensor through a second input terminal, and outputs a current second tensor or first tensor in response to a keep signal. Each of the plurality of multipliers may include a multiplier core that performs a multiplication operation by using, as operands, a 5-bit first tensor and a 5-bit second tensor. Each of the plurality of multipliers may include a first register for storing an output of a multiplier core. Each of the plurality of multipliers may include a second register for storing an output of the first MUX. Each of the plurality of multipliers may include a second MUX that receives a value stored in the second register through a first input terminal, receives an output of the first MUX through a second input terminal, and outputs a value stored in the second register or an output of the first MUX in response to a bypass signal.

In an embodiment, the value stored in the second register may be maintained through a feedback loop generated by the keep signal.

In an embodiment, the electronic device may include a hardware accelerator that performs 1D sub-word parallelism between the sign and mantissa of the first tensor and the sign and mantissa of the second tensor by using a plurality of multipliers, and performs processing between a shared exponent of the first tensor and a shared exponent of the second tensor by using a shared exponent handler. The electronic device may include a processor configured to execute at least one instruction to control the hardware accelerator, based on deep neural network information including at least one of the number of layers in the deep neural network, the types of layers, the shapes of tensors, the dimensionality of the tensors, the operation mode, a bit precision, the type of batch normalization, the type of a pooling layer, and the type of a ReLU function. The electronic device may include a memory storing the at least one instruction and the deep neural network.

In an embodiment, the processor may execute the at least one instruction to obtain at least one of a bit precision and a block size of the deep neural network, based on a user input. The processor may execute the at least one instruction to set at least one of the bit precision and the block size of the first tensor and the second tensor based on at least one of the obtained bit precision and block size. The processor may execute the at least one instruction to control the hardware accelerator to train the deep neural network based on the setting.

In an embodiment, the hardware accelerator may operate in the 2D operation mode in which results of computation by a plurality of multipliers are output without being accumulated in a channel direction, or in the 3D operation mode in which results of computation by the plurality of multipliers are accumulated in the channel direction and a result of accumulating the results of computation is output.

Hereinafter, the major characteristics reflected in the design of the hardware accelerator using a simulator as described above will be described.

[Hardware Efficiency]

The area and power are important design considerations as they affect the performance and energy consumption. In the disclosure, various methods for reducing the area and energy consumption were applied even in the process of designing the hardware accelerator.

First, for the PE, bypass is supported on a multiplier to reduce the number of on-chip memory accesses for weights and an input bandwidth. Because the accelerator of the disclosure is for training rather than inference, many memory accesses occur.

Meanwhile, a general MAC device fetches data necessary for computations from an on-chip buffer in one cycle. In a case of a low-precision mode, a large amount of data needs to be loaded into the MAC device in one cycle, and thus, a large bandwidth is required between the on-chip buffer and the MAC device. To solve this issue, the MAC device in the above-described accelerator supports bypass.

Second, an increase in hardware efficiency. Here, the hardware efficiency refers to the efficiency with respect to the area and power consumption. In the disclosure, methods of 1) reducing the number of shifters, 2) replacing floating-point operators with integer operators, and 3) performing operand isolation were used to increase the hardware efficiency.

Among MAC operators supporting various precisions, there is a 2D sub-word parallelism operator as a solution that has high utilization for all supported precisions and high hardware efficiency. The operator has a large number of shifters. In the disclosure, the operator was divided into 1D sub-word parallelism operators, and 1D sub-word parallelism operators having the same shifter were clustered. The clustered operators share shifters, and accordingly, the number of shifters of the sub-word parallelism operator was significantly reduced. For reference, a group obtained by the clustering is referred to as a PE in the disclosure. Such a decrease in the number of shifters reduces the area of the operator.

Meanwhile, because the processing core in the hardware accelerator proposed in the disclosure supports BFP, all units in the subcore includes integer operators. The integer operators have a simpler structure than those of floating point-type operators, and thus have a smaller area and lower power consumption. The hardware accelerator has high logic density and low power consumption by replacing a large number of floating-point operators with integer-type operators.

Meanwhile, all modules selectively used in the disclosure are designed with operand isolation involved. For example, when the first processing device is operating, the second processing device needs not to operate. Similarly, when the second processing device is operating, the first processing device needs not to operate. Devices that are not operated in the disclosure are made into an idle state such that dynamic power consumption occurring in the device may be reduced.

Third, high utilization rate. In the related art, computations were performed without distinguishing between the 2D operation mode and the 3D operation mode. In a case of the 2D operation mode, unlike the 3D operation mode, results of computation are not accumulated in the channel direction, and thus, the amount of generated output results is much larger than that in the 3D operation mode. However, only a part of the output results may be output due to the limited bandwidth of the devices. For this reason, the related-art accelerators used only a part of operators in the 2D operation mode. To solve the issue of low utilization of related-art devices, the disclosure has a first processing device and a second processing device. The first processing device is dedicated to the 2D operation mode, and the second processing device is dedicated to the 3D operation mode. The first processing device has a high input bandwidth, such that many output result values generated by operators may be transferred to the device. The values transmitted in this way are finally output through round-to-nearest-type quantization. By configuring the first processing device in such a manner, the operators may have a high utilization rate in a limited bandwidth.

Fourth, segmentation of a loss gradient map. In the related art, low utilization was achieved in a weight update step. In detail, In the related art, only a forward pass of DNN training was focused, that is, it was optimized for computations between a large feature map and a small feature map. However, weight update is a computation between a large feature map and a large feature map. In this regard, the related-art accelerators had low utilization in the weight update step. In order to solve such an issue, in the disclosure, one feature map is cut into small-sized feature maps in the weight update step to have a high utilization rate as in a forward pass.

Fifth, in the disclosure, computations are performed with precisions of different sizes for respective steps, and thus may be efficiently performed. For example, it is necessary to perform computations with a high precision in an update process, but the performance is not greatly affected even when computations are performed with a low precision in other processes. Therefore, by performing fast computations with a low precision for operations other than the weight update process and performing computations with a high precision in the weight update process, computation operation may be efficiently performed without degradation of training performance throughout the training process.

Meanwhile, the processing methods according to various embodiments described above may be implemented in the form of program code for performing each operation, stored in a recording medium, and then distributed. In this case, a device loaded with the recording medium may perform the above-described processing operations.

Such recording media may be various types of computer-readable media, such as ROM, RAM, a memory chip, a memory card, an external hard drive, a hard drive, a CD, a DVD, a magnetic disk, or a magnetic tape.

The disclosure has been described with reference to the accompanying drawings, but the scope of the disclosure is intended to be determined by the appended claims, and is not intended to be interpreted as being limited to the above-described embodiments and/or drawings. Also, it should be clearly understood that alterations, modifications, and amendments of the disclosure described in the claims that are obvious to those skill in the art are also included in the scope of the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A hardware accelerator for performing computation of a deep neural network, the hardware accelerator comprising:
a processing core comprising a plurality of multipliers configured to perform one-dimensional (1D) sub-word parallelism between a sign and a mantissa of a first tensor and a sign and a mantissa of a second tensor;
a first processing device configured to operate in a two-dimensional (2D) operation mode in which results of computation by the plurality of multipliers are output; and
a second processing device configured to operate in a three-dimensional (3D) operation mode in which results of computation by the plurality of multipliers are accumulated in a channel direction and then a result of accumulating the results of computation is output.

2. The hardware accelerator of claim 1, wherein a first group of the plurality of multipliers performs a multiplication operation between a series of sub-words of a first value included in the first tensor, and a first sub-word among a series of sub-words of a second value included in the second tensor, and
a second group of the plurality of multipliers performs a multiplication operation between the series of sub-words of the first value, and a second sub-word among the series of sub-words of the second value.

3. The hardware accelerator of claim 1, wherein, in the computations of the deep neural network, the hardware accelerator operates in the 2D operation mode when performing a weight gradient computation, depthwise (DW) convolution, dilated convolution, or up convolution, in which results of computation are not accumulated in a channel direction, and operates in the 3D operation mode when performing convolution, pointwise convolution, or fully-connected layer computations in which results of computation are accumulated in the channel direction.

4. The hardware accelerator of claim 1, wherein the processing core comprises six subcores,
each of the subcores comprises four processing units,
each of the processing units comprises four processing elements, and
each of the processing elements comprises nine multipliers.

5. The hardware accelerator of claim 4, wherein, in a case of computations of a Conv3 layer of the deep neural network, based on a size of the sign and the mantissa of the first tensor being 16 bits, the first tensor corresponding to one input channel of the Conv3 layer is broadcast to four processing units constituting one subcore,
based on the size of the sign and the mantissa of the first tensor being 8 bits, the first tensor corresponding to two input channels of the Conv3 layer is broadcast to four processing units constituting one subcore, and
based on the size of the sign and the mantissa of the first tensor being 4 bits, the first tensor corresponding to four input channels of the Conv3 layer is broadcast to four processing units constituting one subcore.

6. The hardware accelerator of claim 4, wherein, in a case of computations of a Conv3 layer of the deep neural network, based on a size of the sign and the mantissa of the second tensor being 16 bits, the second tensor corresponding to one output channel of the Conv3 layer is distributed to four processing units constituting one subcore,
based on the size of the sign and the mantissa of the second tensor being 8 bits, the second tensor corresponding to two output channels of the Conv3 layer is distributed to four processing units constituting one subcore, and
based on the size of the sign and the mantissa of the second tensor being 4 bits, the second tensor corresponding to four output channels of the Conv3 layer is distributed to four processing units constituting one subcore.

7. The hardware accelerator of claim 4, wherein the first processing device comprises:
six 4-way adder trees configured to sum up outputs of the four processing units included in each of the six subcores;
six bit truncators configured to round off each of outputs of the 4-way adder trees to have a preset number of bits;
a selective 6-way adder tree configured to selectively sum up outputs of the bit truncators;
an arithmetic converter configured to output FP32 partial sum data, based on an output of the selective 6-way adder tree and an output of a shared exponent handler; and
an accumulator configured to accumulate the FP32 partial sum data.

8. The hardware accelerator of claim 4, wherein the second processing device comprises:
four 6-way adder trees each configured to sum up outputs of processing units corresponding to each other in different subcores;
four arithmetic converters configured to output FP32 partial sum data, based on outputs of the 6-way adder trees and an output of a shared exponent handler;
four accumulators configured to accumulate the FP32 partial sum data; and
a selective 4-way adder tree configured to selectively sum up outputs of the accumulators.

9. The hardware accelerator of claim 4, wherein each of the processing units comprises:
the nine multipliers configured to perform a multiplication operation;
a 9-way adder tree configured to sum up outputs of the nine multipliers; and
a selective shift logic circuit configured to shift an output of the 9-way adder tree by a preset number of bits.

10. The hardware accelerator of claim 1, further comprising a shared exponent handler configured to process a shared exponent of the first tensor and a shared exponent of the second tensor.

11. The hardware accelerator of claim 1, wherein the processing core is configured to perform a computation by using numbers of data types corresponding to a control signal, and
the data types comprise a first data type of fixed-point format, a second data type having only integers, a third data type having a sign and an integer, and a fourth data type of a real-number format sharing an exponent.

12. The hardware accelerator of claim 1, wherein a size of a shared exponent of the first tensor and a size of a shared exponent of the second tensor are 8 bits,
a size of the sign and the mantissa of the first tensor or a size of the sign and the mantissa of the second tensor is one of 4 bits, 8 bits, and 16 bits, and
based on the size of the sign and mantissa of the first tensor or the size of the sign and mantissa of the second tensor, the first tensor and the second tensor are mapped to the processing core.

13. The hardware accelerator of claim 12, wherein the size of the sign and the mantissa of the first tensor or the size of the sign and the mantissa of the second tensor is determined based on a forward pass step, a backward pass step or a weight update step of training of the deep neural network.

14. The hardware accelerator of claim 1, further comprising a core output buffer configured to output an output value of the first processing device in a weight update step, and output an output value of the second processing device in a forward pass step and a backward pass step.

15. The hardware accelerator of claim 14, further comprising:
a batch normalization circuit configured to perform batch normalization based on an output of a core output buffer;
a rectified linear unit (ReLU)-pool circuit configured to perform a ReLU function value and a pooling value, based on an output of the batch normalization circuit;
a first in, first out (FIFO) circuit configured to store and output an output of the ReLU-Pool circuit;
an FP2BFP converter circuit configured to convert a data type of an output of the FIFO circuit in a floating-point format, into a block floating point format; and
a quantization circuit configured to quantize an output of the FP2BFP converter according to a predefined precision.

16. The hardware accelerator of claim 1, wherein each of the plurality of multipliers comprises:
a first multiplexer (MUX) configured to receive a previous second tensor through a first input terminal, receive a current second tensor through a second input terminal, and output the current second tensor or the first tensor in response to a keep signal;
a multiplier core configured to perform a multiplication operation by using, as operands, the first tensor of 5 bits and the second tensor of 5 bits;
a first register configured to store an output of the multiplier core;
a second register configured to store an output of the first MUX; and
a second MUX configured to receive, through a first input terminal, a value stored in the second register, receive the output of the first MUX through a second input terminal, and output, in response to a bypass signal, the value stored in the second register or the output of the first MUX.

17. The hardware accelerator of claim 16, wherein the value stored in the second register is maintained through a feedback loop generated by the keep signal.

18. An electronic device for performing training and inference of a deep neural network, the electronic device comprising:
a hardware accelerator configured to perform one-dimensional (1D) sub-word parallelism between a sign and a mantissa of a first tensor and a sign and a mantissa of a second tensor by using a plurality of multipliers, and performing processing between a shared exponent of the first tensor and a shared exponent of the second tensor by using a shared exponent handler;
a processor configured to execute at least one instruction to control the hardware accelerator, based on deep neural network information comprising at least one of: the number of layers in the deep neural network, types of layers, shapes of tensors, dimensionality of the tensors, an operation mode, a bit precision, a type of batch normalization, a type of a pooling layer, and a type of a rectified linear unit (ReLU) function; and
a memory storing the at least one instruction and the deep neural network.

19. The electronic device of claim 18, wherein the at least one processor is further configured to execute the at least one instruction to obtain at least one of a bit precision and a block size of the deep neural network, based on a user input, set at least one of a bit precision and a block size of the first tensor and the second tensor, based on at least one of the obtained bit precision and block size, and control the hardware accelerator to train the deep neural network, based on the setting.

20. The electronic device of claim 18, wherein the hardware accelerator is further configured to operate in a two-dimensional (2D) operation mode in which results of computation by a plurality of multipliers are output without being accumulated in a channel direction, or in a three-dimensional (3D) operation mode in which results of computation by the plurality of multipliers are accumulated in the channel direction and a result of accumulating the results of computation is output.
